(19) United States
(12) Patent Application Publication
(10) Pub. No.: US 2006/0253263 A1
(43) Pub. Date: Nov. 9, 2006

(54) Method to optimize drug selection, dosing and evaluation and to help predict therapeutic response and toxicity from immunosuppressant therapy

(76) Inventor: Brian Javaade Meshkin, Temecula, CA (US)

Correspondence Address: AMIN LAW, LLC, 217 N. JEFFERSON ST., SUITE 100, CHICAGO, IL, 60661, US

(21) Appl. No.: 11/402,173

(22) Filed: Apr. 11, 2006

Related U.S. Application Data
(60) Provisional application No. 60/669,993, filed on Apr. 11, 2005.

(51) Int. Cl. G06F 19/00

(52) U.S. Cl. 702/20

(57) ABSTRACT

The present invention provides a method of effectively measuring risk for therapeutic toxicity of a subject having an autoimmune disorder or cancer and predicting and evaluating therapeutic efficacy of immunosuppressive therapies for autoimmune diseases and cancers before or after starting therapy. The present invention also provides for determining a drug metabolite level of a subject during therapy and measuring periodically the drug metabolite level of a subject on maintenance therapy to ensure treatment compliance and continued therapeutic response by measuring minimal clinical important differences (MCID) in the drug metabolite levels. The present invention also provides for a method to effectively optimize the selection and dose of immunosuppressive therapies of a subject having an autoimmune disease or cancer to improve therapeutic efficacy and reduce therapeutic toxicity prior to starting concomitant biologic therapy and before or after the subject has failed to respond to the at least one immunosuppressive agent.

### CROSS REFERENCE TO RELATED APPLICATIONS

This application claims the benefit of U.S. provisional application No. 60/669,993 filed on Apr. 11, 2005.

### FIELD OF THE INVENTION

The present invention relates to a method for effectively measuring risk for therapeutic toxicity before or after starting therapy and a method to predict and evaluate therapeutic efficacy in chemotherapy treatment of cancer and immunosuppressive and biologic therapy of autoimmune and immune-mediated disorders in order to improve treatment response and improve health outcomes.

### BACKGROUND OF THE INVENTION

In recent years, scientists have attempted to study cells and living systems through the cataloging of the entire genome of an organism (e.g., genomics). Genomics is a powerful tool, useful for identifying and interrogating the entire inventory of genes of a living system. Recently, scientists have also attempted to identify and interrogate all the proteins present in the cell or organism through proteomics. However, most pharmaceutical companies who study genomics and proteomics realize that many of their anticipated products are not proteins nor genes but small molecules.

For example, once a novel gene or target is discovered by genomics, the pharmaceutical investigators must first validate the target using expensive and time-consuming procedures, which are far removed from the actual disease state. Examples of typical validation procedures include expression profiling, generating knock-out mice or transgenic mice, in situ hybridization, etc. Once a target is validated, the investigators typically screen enormous random small molecule libraries to identify molecules which interact with the protein targets. The identified small molecules are typically optimized through chemical synthesis in order to obtain a marketable pharmaceutical product.

At the same time that a pharmaceutical target is validated, the investigators generally develop a research and development laboratory assay to recognize this small molecule in a cellular component of the body and its interaction with the protein targets. Usually these companion laboratory tests remain in the research and development laboratories of these investigators and are not made commercially available to clinicians who ultimately use the product for therapy.

Metabolomics offer a viable means to predict and measure therapeutic response. In addition, metabolomics can be used in tandem with genomics and/or proteomics. For example, small molecule profiles can be used to identify small molecules regulated, modulated, or associated with genetic modification or alterations of cells, both engineered and naturally occurring. In addition, metabolomics can also be applied to the field of predictive medicine. Unlike pharmacogenetics, which is limited to genetic factors, pharmaco-metabolomics is able to predict an individual's response to a drug based not only on genetic factors, but also non-genetic factors, such as other drugs in the patient's body, the patient's current state of health, etc.

Methotrexate therapy offers some foundational research to this field of pharmaco-metabolomics. Folate (folic acid) is a vitamin that is essential for the life-sustaining processes of DNA synthesis, replication and repair. Folate is also important for protein biosynthesis, another process that is central to cell viability. The pteridine compound, methotrexate (MTX), is structurally similar to folate and as a result can bind to the active sites of a number of enzymes that normally use folate as a coenzyme for the biosynthesis of the purine and pyrimidine nucleotide precursors of DNA and for the interconversion of amino acids during protein biosynthesis. Despite its structural similarity to folic acid, MTX cannot be used as a cofactor by enzymes that require folate, and instead competes with the folate cofactor for enzyme binding sites, thereby inhibiting protein and DNA biosynthesis and, hence, cell division.

The ability of methotrexate to inhibit cell division has been exploited in the treatment of a number of diseases and conditions that are characterized by rapid or aberrant cell growth. As an example, autoimmune diseases are characterized by an inappropriate immune response directed against normal autologous (self) tissues and are mediated by rapidly replicating T-cells or B-cells. Autoimmune diseases that have been treated with MTX include, for example, multiple sclerosis, rheumatoid arthritis, psoriasis, the autoimmune stage of diabetes mellitus (juvenile-onset or Type 1 diabetes), autoimmune uveoretinitis, myasthenia gravis, autoimmune thyroiditis, and systemic lupus erythematosus.

Because many malignant cells proliferate more rapidly than normal cells, MTX can also be used to selectively impair cancerous cell growth. As a consequence, methotrexate is a widely used anticancer agent, employed, for example, in the treatment of acute lymphocytic leukemia, breast cancer, epidermoid cancers of the head and neck, advanced mycosis fungoides, lung cancer, non-Hodgkins lymphomas, gestational choriocarcinoma, chorioadenoma destruens, and hydatidiform moles.

Despite its therapeutic efficacy for a wide variety of diseases and conditions, treatment with methotrexate can present a risk to the patient. In particular, because MTX interferes with processes required for replication and division of normal as well as diseased cells, inappropriately high levels of the drug can lead to destruction of actively proliferating non-target tissues such as bone marrow and intestinal mucosa. MTX consequently is associated with renal and hepatic toxicity when administered in the “high-dose regimen” that is required for some conditions. In addition, low-dose MTX therapy can lead to toxicity and unwanted side-effects in some patients, where the dosage is not appropriate due to individual variability in pharmacokinetic parameters influencing, for example, drug uptake, targeting and clearance. This situation is especially problematic in the treatment of chronic conditions such as rheumatoid arthritis, where methotrexate can be administered over a period of many years.

Observational studies indicate that more than half of patients who take MTX continue the drug beyond 3 years, significantly longer than any other disease modifying anti-rheumatic drugs (DMARD) (Guidelines for the Management of Rheumatoid Arthritis, ACR Subcommittee on Rheumatoid Arthritis, page 337, April 2002.). In looking at five trials and 300 patients in a Cochrane review of “Methotrexate for treating rheumatoid arthritis”, it was observed that patients on MTX were three times more likely than placebo to discontinue treatment due to adverse reactions. In these studies observed, twenty-two percent of people on MTX withdrew due to adverse effects compared to seven percent of the placebo group (Suarez-Almazor M E, Belseck E, Shea B, Wells G, Tugwell P, Methotrexate for treating rheumatoid arthritis, Cochrane Review CD000957—most recent amendment Aug. 2, 2002.). In an observational study of 437 patients over a decade by Ortendahl et al, it was observed that it took 3 or more years to reach an optimal dose of methotrexate therapy. The study authors concluded that MTX dosing “appears suboptimal by being too little, too late, and too long to treatment change” (Ortendahl M, Holmes T, Schettler J D, Fries J F, The Methotrexate Therapeutic Response in Rheumatoid Arthritis, Journal of Rheumatology, 29:20842-2091, 2002.).

Because individual differences in pharmacokinetic parameters can be difficult to predict, safe and effective methotrexate treatment strategies require that methotrexate or methotrexate metabolite levels be monitored in patients being treated. A variety of methods have been developed for monitoring MTX drug concentrations in plasma including bioassays, immunological detection and chromatographic assays. Such plasma detection methods have been useful for monitoring high dose MTX therapy in some clinical applications. However, these plasma detection methods have not been useful in monitoring low-dose methotrexate therapy.

Methotrexate is metabolized upon uptake by mammalian cells, such that one or more glutamyl moieties are added to MTX to yield a mixture of methotrexate polyglutamates (MTXPGs). The number of glutamyl moieties that can be added to MTX generally varies from two to seven. MTXPGs do not readily efflux from cells and thus are able to exert their cytotoxic effects over long periods of time. Levels of intracellular MTXPGs have been shown to be higher in patients that responded to MTX therapy as compared the intracellular levels in patients that did not respond. Currently available methods for measuring cellular MTXPG levels are based on a dihydrofolate reductase enzyme assay in which MTXPG levels are calculated based on inhibition of the dihydrofolate reductase enzyme. However, the extent of enzyme inhibition in these assays is dependent upon the number of glutamyl residues attached to MTX, rendering an accurate determination of intracellular MTXPGs levels impossible by this method. The variability of dihydrofolate reductase based assays can be further exacerbated in some situations because folates, which are present in different amounts depending upon an individual's response to MTX therapy and the amount of folate contributed by diet, also influence the results of the assay.

Low dose weekly methotrexate was first used to treat patients with active rheumatoid arthritis in the 1970s. Over the years, methotrexate has become the most widely used agent among DMARD and has been ranked ahead of such drugs in terms of its efficacy/toxicity ratio (O'Dell, Rheum. Dis. Clin. North Am., 23:779-796 (1997)). In particular, one-third of rheumatoid arthritis patients show major improvement on methotrexate, with this drug generally preferred over azathioprine, sulfasalazine, gold salts and penicillamine because of its relatively favorable ratio of efficacy to toxicity (Felson et al., Arthritis Rheum., 35:1117-1125 (1992); Maetzel et al., Rheum., 39:975-981 (2000); and Alarcn et al., J. Rheum., 19:1868-1873 (1992)). In some cases, methotrexate is combined with other disease modifying anti-rheumatic drugs such as sulfasalazine and hydroxychloroquine or other anti-inflammatory agents, for example, anti-cytokine therapeutics such as anti-tumor necrosis factor-.alpha. antibodies (O'Dell, Rheum. Dis. Clin. North Am., 24:465-477 (1998); Kremer et al., Rheum. Dis. Clin. North Am., 24:651-658 (1998); and O'Dell and Scott, Rheum., 38 Suppl. 2:24-26 (1999)).

Most patients demonstrate a dose dependent response to methotrexate, which is generally administered weekly (Furst et al., J. Rheum., 16:313-320 (1989)). Adverse effects are also dose-dependent, and adverse effects, rather than lack of efficacy, are the most common reason for discontinuing methotrexate therapy (Alarcon et al., Arthritis Rheum., 32:671-676 (1989)). In rheumatoid arthritis patients on methotrexate, mild adverse effects occur in up to 60% of patients, with roughly 7 to 30% of patients discontinuing therapy within the first year of treatment (Schnabel and Gross, Sem. Arthritis Rheum., 23:310-327 (1994); Kremer and Phelps, Arth. Rheum., 35:138-145 (1992)). Gastrointestinal intolerance such as nausea, abdominal pain, indigestion or diarrhea; asymptomatic elevation of serum hepatic transaminase levels; and stomatitis are the major reasons for dose reduction or premature discontinuation of methotrexate therapy (Kremer, Scand. J. Rheum., 25:341-344 (1996); Morgan et al., Arth. Rheum., 0.30:1348-1356 (1987); Andersen et al., J. Rheum., 24:830-837 (1997); Leeb et al., Clin. Exp. Rheum., 13:459-463 (1995); and Dijkmans, J. Rheum., 34:1172-1174 (1995)). In addition to dose and duration of treatment, other factors such as folate deficiency, advanced age, cumulative dose, renal insufficiency and concomitant use of other anti-folates can influence methotrexate toxicity (Wallace and Sherry, J. Rheum., 22:1009-1112 (1995); and Jackson, Pharm. Ther., 25:61-82 (1984)).

Many adverse effects such as gastrointestinal intolerance, stomatitis, alopecia and cytopenia mimic folate deficiency and can be explained by the antifolate properties of methotrexate (Bannwarth et al., Drugs, 47:25-50 (1994); Van Ede et al., Sem. Arthr. Rheum., 27:277-292 (1998); and Segal et al., Sem. Arthr. Rheum., 20:190-200 (1990)). Depleted intracellular folate levels have been documented in hepatocytes and peripheral blood lymphocytes of methotrexate-treated patients (Stenger et al., Ann. Rheum. Dis., 51:1019-1020 (1992); Morgan et al., Clin. Pharm. Ther., 50:547-556 (1991); Kremer et al., Arth. Rheum., 29:832-834 (1986); Leeb et al., supra, 1995; Morgan et al., Arth. Rheum., 30:1348-1356 (1987); Hine et al., Arth. Rheum., 33 (Suppl.): S60 (1990); and Stewart et al., Sem. Arth. Rheum., 331:906-908 (1988)). Folate deficiency occurs frequently in patients with rheumatoid arthritis, and folate stores are further decreased in rheumatoid arthritis patients taking methotrexate (Leeb et al., supra, 1995). Several studies have shown the advantages of folic or folinic acid supplementation in rheumatoid arthritis and other patients undergoing treatment with methotrexate (Ortiz et al., J. Rheum., 25:36-43 (1998)); Kremer et al., supra, 1996; Dijkmans, supra, 1995; Bannwarth et al., supra, 1994; Van Ede et al., supra, 1998; Segal et al., supra, 1990; Cronstein, Arthr. Rheum., 39:1951-1960 (1996); Endresen and Husby, Scand. J. Rheum., 30:129-134 (2001); Griffith et al., Rheum., 39:1102-1109 (2000); and van Ede et al., Arth. Rheum., 44:1515-1524 (2001)). As an example, in double-blind studies, 5 mg of folic acid or 2.5 to 5 mg per week of folinic acid, an activated form of folic acid, substantially reduced side effects of methotrexate without interfering with therapeutic efficacy in rheumatoid arthritis patients (Morgan et al., Ann. Intern. Med., 121:833-841 (1994); and Shiroky et al., Arthr. Rheum., 36:795 (1993)). Similarly, 5 mg per day folic acid was shown to alleviate the side effects from methotrexate observed in patients with severe psoriasis (Duhra, J. Am. Acad. Dermatol., 28:466-469 (1993)). The folic or folinic acid was generally prescribed to be taken at a different time from methotrexate and, in some cases, was prescribed to be taken only five days per week.

Thiopurine Therapy (Azathioprine and 6-Mercaptopurine) provides further foundational research to the use of pharmacogenetics and metabolomics in treatment optimization for inflammatory bowel disease.

Immune-mediated disorders encompass a wide range of debilitating gastrointestinal and arthritic diseases of various etiologies. One such immune-mediated gastrointestinal disorder, inflammatory bowel disease (IBD), is the collective term used to describe two gastrointestinal disorders of unknown etiology: Crohn's disease (CD) and ulcerative colitis (UC). The course and prognosis of IBD, which occurs world-wide and is reported to afflict as many as two million people, varies widely. Onset of IBD is predominantly in young adulthood with diarrhea, abdominal pain, and fevers the three most common presenting symptoms. The diarrhea may range from mild to severe and in ulcerative colitis often is accompanied by bleeding. Anemia and weight loss are additional common signs of IBD. Ten percent to fifteen percent of all patients with IBD will require surgery over a ten year period. In addition, patients with IBD are at increased risk for the development of intestinal cancer. Reports of an increasing occurrence of psychological problems, including anxiety and depression, are perhaps not surprising as IBD is a debilitating disease that strikes people in the prime of life.

6-Mercaptopurine (6-MP) and azathioprine (AZA), a pro-drug that is non-enzymatically converted to 6-mercaptopurine (6-MP), are 6-MP drugs that can be used as an effective treatment for inflammatory bowel diseases such as Crohn's disease and ulcerative colitis (Kirschner Gastroenterology 115:8.13-821 (1998)). 6-MP can be enzymatically converted to various 6-MP metabolites, including 6-methyl-mercaptopurine (6-MMP) and 6-thioguanine (6-TG) and their nucleotides. 6-TG nucleotides are thought to be the active metabolite in mediating many of the effects of 6-MP drug treatment.

Thiopurine methyltransferase (TPMT) is a cytoplasmic enzyme that preferentially catalyzes the S-methylation of 6-MP and 6-TG to form S-methylated metabolites such as 6-MMP and 6-methylthioguanine (6-MTG), respectively. TPMT exhibits genetic polymorphism, with 89% of Caucasians and African Americans having high activity, 11% intermediate activity and 1 in 300 TPMT deficient. Clinical studies with AZA and 6-MP have shown an inverse relationship between TPMT activity and 6-TGN accumulation. Patients who less efficiently methylate these thiopurines have more extensive conversion to 6-TGN, which can lead to potentially fatal hematopoietic toxicity. Therefore, patients who have less active TPMT can be more susceptible to toxic side effects of 6-MP therapy.

Although drugs such as 6-MP and AZA have been used for treating IBD, non-responsiveness and drug toxicity unfortunately complicate treatment in some patients. Complications associated with 6-MP drug treatment include allergic reactions, neoplasia, opportunistic infections, hepatitis, bone marrow suppression, and pancreatitis. Therefore, many physicians are reluctant to treat patients with AZA because of its potential side effects, especially infection and neoplasia.

Lupus is also an autoimmune disease which is treated with thiopurines as maintenance therapy following response induction from Cyclophosphamide or Mycophenolate Mofetil (CellCept, Roche). Cyclophosphamide (CYC) has been generally accepted as the standard of care for induction therapy as part of treatment for severe lupus nephritis (LN) and other life-threatening manifestations of systemic lupus erythematosus (SLE). Both short- and long-term toxicity of CYC, especially the risk for infection, premature gonadal failure, and lymphoproliferative malignancies, has led to an attempt to minimize the exposure to this agent for both induction and maintenance of remission. Several studies examining the efficacy and toxicity of various CYC regimens in SLE were published during the past 2 years. Of considerable interest was the Euro-Lupus Nephritis Trial by Houssiau et al. (Houssiau F A, Vasconcelos C, D'Cruz D, et al., Immunosuppressive therapy in lupus nephritis, The Euro-Lupus Nephritis Trial, a randomized trial of low-dose versus high-dose intravenous cyclophosphamide, Arthritis Rheum., 2002, 46:2121-2131) in which 90 patients with class IV LN were assigned by the method of minimization to receive either high-dose (six monthly pulses followed by two quarterly pulses) or low-dose (500 mg biweekly×six pulses) intravenous (IV) CYC induction followed by azathioprine (AZA) maintenance in a dose of 1 mg/kg/day. Renal remission was achieved in 71% of the low-dose group and in 54% of the high-dose group, with subsequent renal flares occurring in 27% and 29% respectively. Severe infections were twice as frequent in the high-dose group. None of the differences between groups reached statistical significance. Low-dose IV CYC followed by maintenance AZA may be a less toxic and equally effective alternative to standard IV CYC therapy for class IV LN.

Despite its acceptance as the standard of care for treatment of severe LN, a significant proportion of patients fail to achieve a remission with CYC, or experience a relapse of active nephritis during maintenance therapy. (Illei G G, Takada K, Parkin D, et al., Renal flares are common in patients with severe proliferative lupus nephritis treated with immunosuppressive therapy: long-term followup of a cohort of 145 patients participating in randomized controlled studies. Arthritis Rheum., 2002, 46:995-1002). It has been suggested by some but not all investigators that children may have a poorer response to CYC than adults. (Al Salloum A A, Cyclophosphamide therapy for lupus nephritis: poor renal survival in Arab children, Pediatr Nephrol, 2003, 18:357-361, Lehman T J, Edelheit B S, Onel K B, Combined intravenous methotrexate and cyclophosphamide for refractory childhood lupus nephritis, Ann Rheum Dis, 2004, 63:321-323; and Barbano G, Gusmano R, Damasio B, et al., Childhood-onset lupus nephritis: a single-center experience of pulse intravenous cyclophosphamide therapy, J Nephrol, 2002, 15:123-129).

In a number of reports, the lack of efficacy of CYC appeared to be related to racial, ethnic, or socioeconomic factors. Dooley et al. observed that nonblack patients with class IV LN retained a stable renal survival rate of 95% through 5 years of follow-up, whereas black patients had a progressive decline in renal survival to 71% at year 5. (Dooley M A, Hogan S, Jennette C, et al., Cyclophosphamide therapy for lupus nephritis: poor renal survival in black Americans, Kidney Int, 1997, 51:1188-1195). Two recent reports suggest that the outcome of IV CYC therapy in a Jamaican SLE cohort of African descent and a Chilean SLE population may be poorer than that seen in controlled clinical trials. The high frequency and severity of renal insufficiency at onset of therapy, as well as socioeconomic factors, may explain these differences. (Williams W, Bhagwandass A, Sargeant L A, et al., Severity of systemic lupus erythematosus with diffuse proliferative glomerulonephritis and the ineffectiveness of standard pulse intravenous cyclophosphamide therapy in Jamaican patients, Lupus, 2003, 12:640-645; and Velasquez X, Verdejo U, Massardo L, et al., Outcome of Chilean patients with lupus nephritis and response to intravenous cyclophosphamide, J Clin Rheumatol, 2003, 9:7-14). Barr et al. performed a novel examination of the outcome in 128 patients with proliferative LN at Columbia Presbyterian Medical Center (Barr R G, Seliger S, Appel G B, et al., Prognosis in proliferative lupus nephritis: the role of socio-economic status and race/ethnicity, Nephrol Dial Transplant, 2003, 18:2039-2046). This retrospective review of a large series of patients with proliferative lupus nephritis points out the important association of poverty with poor outcome and found that poverty, defined as residence in a poor neighborhood, was associated with doubling of serum creatinine after adjustment for age, gender, hypertension, CYC therapy, and race/ethnicity (RR=3.5, P=0.03). The influence of Hispanic ethnicity was retained after adjustment for poverty and insurance status, whereas the effect of African-American race was not. These reports point out the necessity to consider the racial/ethnic and socioeconomic balance of lupus cohorts when recruiting patients for clinical trials. Both the imperfect efficacy and toxicity of CYC have led investigators to search for alternative therapies for severe manifestations of SLE, particularly LN.

Mycophenolate mofetil (MMF; CellCept) has received considerable attention regarding its use in both anecdotal series and controlled clinical trials. MMF is a reversible inhibitor of inosine monophosphate dehydrogenase, the rate-limiting enzyme in purine synthesis, and is approved for the prevention of allograft rejection. It has a selective effect on lymphocytes, thereby decreasing the potential for hematologic toxicity. A number of case reports and uncontrolled series have described the experience with MMF in SLE, usually in patients unresponsive to steroids and CYC, or with unacceptable toxicity. (Alba P, Karim M Y, Hunt B J, Mycophenolate mofetil as a treatment for autoimmune hemolytic anemia in patients with systemic lupus erythematosus and antiphospholipid syndrome, Lupus, 2003, 12:633-635; Samad A S, Lindsley C B, Treatment of pulmonary hemorrhage in childhood systemic lupus erythematosus with mycophenolate mofetil, South Med J, 2003, 96:705-707; and Kapitsinou P P, Boletis J N, Skopouli F N, et al., Lupus nephritis: treatment with mycophenolate mofetil, Rheumatology, 2004, 43:377-380). In a retrospective review of 18 patients with LN, MMF appeared to be safe and effective in those with proliferative histology, whereas efficacy in membranous LN was not observed. (Riskalla M, Somers E C, Fatica R A, et al., Tolerability of mycophenolate mofetil in patients with systemic lupus erythematosus, J Rheumatol, 2003, 30:1508-1512). Another retrospective review of 54 consecutive patients treated with MMF describes the most common side effects of this agent and the reasons for drug discontinuation. (Doria A, Frassi M, Della Libera S, et al., Prospective study on tolerability and efficacy of mycophenolate mofetil (MMF) in SLE, Arthritis Rheum, 2003, 48:S587). A prospective review of 42 patients, some with refractory manifestations of active lupus and others with newly diagnosed nephritis, found MMF therapy to be well tolerated and effective in reducing overall disease activity. (Ferro M L, Karim M Y, Abbs I C, et al., Mycophenolate mofetil: a potential treatment for reducing proteinuria associated with membranous lupus nephritis, Arthritis Rheum, 2003, 48:S588). In 2000, Chan et al. showed the potential benefits of using MMF in a randomized, controlled, open-label study comparing this agent with oral CYC in 42 patients with class IV LN. (Chan T M, Li F K, Tang C S O, et al., Efficacy of mycophenolate mofetil in patients with diffuse proliferative lupus nephritis, N Engl J Med, 2000, 343:1156-1162). The efficacy of MMF and CYC were found to be equivalent, with similar toxicity, in this 1-year study at a single center. In another single-center, randomized, open-label trial of 46 patients with class IV LN treated for 6 months, Hu et al. found that MMF was more effective in controlling clinical activity than IV CYC. (Hu W, Liu Z, Chen H, et al., Mycophenolate mofetil vs cyclophosphamide therapy for patients with diffuse proliferative lupus nephritis, Chin Med J, 2002, 115:705-709). In a multicenter, randomized, open-label study of 140 patients with severe LN by Ginzler et al., MMF was found to be superior to IV CYC in inducing complete remissions, with better patient tolerability. The 140 patients were randomized to either MMF or IV CYC for induction therapy of LN. Complete remission was observed in 16 patients (23%) on MMF compared with four patients (6%) on IV CYC. Twenty-one patients on MMF versus 17 on IV CYC had a partial remission (combined end point, 37 patients on MMF versus 21 patients on IV CYC, P=0.009). Three deaths occurred, all in patients randomized to IV CYC. There was a trend toward more serious infections in the IV CYC group. Gastrointestinal side effects, particularly nausea/vomiting and diarrhea, were common with MMF, but the episodes were generally self-limited, whereas vomiting and dehydration from IV CYC required hospitalization and drug discontinuation in some patients. The authors concluded that the superior tolerability of MMF with at least equivalent efficacy justifies its consideration as an alternative to IV CYC as a standard-of-care induction regimen for LN. (Ginzler E M, Aranow C, Merrill J T, et al., Toxicity and tolerability of mycophenolate mofetil (MMF) versus intravenous cyclophosphamide (IVC) in a multicenter trial as induction therapy for lupus nephritis (LN), Arthritis Rheum, 2003, 48:S586). In a randomized, open-label study of patients with proliferative LN, Contreras et al. found that induction therapy with IV CYC followed by maintenance therapy with either MMF or AZA appeared to be more efficacious and safer than long-term IV CYC. The study compared the efficacy of MMF, AZA, and IV CYC as a maintenance regimen in 59 patients with proliferative LN induced with IV CYC and followed for as long as 30 months. The primary end points were patient and renal survival. During maintenance therapy, five patients died (four on CYC and one on MMF) and five developed chronic renal failure (three on IV CYC, one on MMF, and one on AZA). Event-free survival at 72 months was higher with MMF or AZA. Relapse-free survival was higher with MMF compared with IV CYC. Hospitalization, amenorrhea, infections, and gastrointestinal side effects were significantly lower in the MMF and AZA groups. (Contreras G, Pardo V, Leclercq B, et al., Sequential therapies for proliferative lupus nephritis, N Engl J Med, 2004, 350:971-980).

Pharmaceutical non-compliance is a tremendous economic and medical problem. Some analyses indicate that, of all medications prescribed, less than 70 percent are actually consumed. Furthermore, as a result of non-compliance as many as 40 percent of patients receiving outpatient drug therapy experience a treatment failure or new medical problem. In the United States, pharmaceutical non-compliance drains an estimated $ 100 billion from the national economy and may account for the deaths of over 125,000 Americans annually, which equates to more than 300 people every day. In addition, ten percent of all hospital admissions are the result of pharmaceutical non-compliance, while more than twenty percent of all nursing home admissions are due to the inability of patients to take their medications as prescribed.

Patient compliance has been defined as “the extent to which an individual's behavior coincides with medical or health advice.” (Remington's Pharmaceutical, Chapter 103, Volume II, page 1796 (19^{th} Sup. Edition (1995)). Conversely, non-compliance encompasses a variety of behaviors including drug underuse, which encompasses taking too low a dose or skipping a dose. Non-compliance also encompasses drug overuse such as taking too high a dose or taking a dose too frequently. Medication compliance is affected by the physician's and pharmacist's relationship with the patient, and, in particular, how clearly the physician or pharmacist explains the treatment regimen to the patient. Non-compliance is generally higher in the elderly population than in other groups; for patients over the age of 65, about 20% of all non-elective hospital admissions are due to mismanagement of prescription medications. The increased incidence of non-compliance in the elderly population may be due, for example, to declining mental function, increasing numbers of medications prescribed or an increase in side effects or drug interactions associated with multiple drug regimens. (Murray et al., DICP 20:146 (1986)). Unfortunately, counseling, education and behavior modification techniques have achieved only limited success in boosting patient compliance.

An emerging body of research suggests that minimal clinical important differences (MCID) can connect validated study and laboratory measures with the clinical presentation of subjects. Brunner et al. evaluated the MCID in the childhood health assessment questionnaire (CHAQ) which is a commonly used instrument in subjects with juvenile rheumatoid arthritis (JRA). (Brunner H I, Kein-gitelman M S, Miller M J, Barron A, Baldwin N, Trombley M, Johnson A L, Kress A, Lovell D J, Giannini E H, Minimal clinically important differences of the childhood health assessment questionnaire, J Rheumatol, 2005 January; 32(1):150-61). In this study, changes in the CHAQ were calculated from parents and children, and changes in the subject's well being, disease activity, flares, and important improvements between visits served as the external standards for the MCID. MCID were defined as the median changes in CHAQ scores wherein the subject had a minimal important improvement or worsening between visits. The MCID for improvement of the CHAQ score was −0.188 at most, while the MCID for worsening was at most +0.125. In this study, the MCID of the CHAQ score was often at or close to the level of the smallest potential difference, suggesting an insensitivity of the CHAQ to important short-term changes. This study demonstrated that the MCID are very relevant to what the physician observes in the clinical setting, potentially even more relevant than internationally validated measures, such as the CHAQ.

To this end, Wrwich recently explored the relationship between the magnitude of the standard error of measurement (SEM) and the established thresholds for MCID for change scores in health-related quality of life (HRQOL) measures. (Wyrwich K W, Minimal important difference thresholds and the standard error of measurement: is there a connection?, J Biopharm Stat., 2004 February;14(1):97-110). This study reviewed and compared two sets of studies: (1) three investigations using a disease-specific HRQOL measure among patient samples with the chronic diseases (heart disease, chronic obstructive pulmonary disease, or asthma) that have consistently demonstrated a 1 SEM correspondence with the established MCID or minimal important differences (MID); and (2) three investigations among patients referred to physical therapists with back, lower extremity, and neck pain showing that approximately 2.3 SEMs estimated the established MCID standards for three different measures of health status. Chronic disease patients were classified to have a MCID or MID if their global change ratings for the better or the worse were 1, 2, or 3 on a Likert scale ranging from 1 (almost the same, hardly any better, or worse at all) to 7 (a very great deal better or worse). Back pain patients, however, needed average global transition scores of 5, 6, or 7 (a good, a great, or a very great deal better) on the same 7-point Likert scale in order to experience an MCID in their condition. Charting these change levels against their respective SEM-MID criteria provides insight and promise for linking SEM-based criteria to MCID standards for other HRQOL and health status measures. Thus, this review connects the SEM and MCID which has particular relevance in the use of laboratory measures that often times have frequent SEMs.

Blumenauer et al. explored the quality of life in patients with refractory rheumatoid arthritis (RA) and concluded that clinical assessments with established MCIDs that affect quality of life (QOL) should be used in clinical studies. (Blumenauer B, Cranney A, Clinch J, Tugwell P, Quality of life in patients with rheumatoid arthritis: which drugs might make a difference?, Pharmacoeconomics, 2003; 21(13):927-40).

Bruynewsteyn K et al. explored the comparison between MCID and the smallest detectable difference (SDD) in RA subjects' joint damage using the Sharp/van der Heijde and Larsen/Scott scoring methods. (Bruynesteyn K, van der Heijde D, Boers M, Saudan A, Peloso P, Paulus H, Houben H, Griffiths B, Edmonds J, Bresnihan B, Boonen A, van der Linden S, Determination of the minimal clinically important difference in rheumatoid arthritis joint damage of the Sharp/van der Heijde and Larsen/Scott scoring methods by clinical experts and comparison with the smallest detectable difference, Arthritis Rheum., 2002 April;46(4):913-20). The international panel judged changes in joint damage around the level of the SDD (5.0) of the Sharp/van der Heijde method as minimal clinically important, resulting in satisfactory sensitivity (mean 79%) and specificity (mean 84%) for detecting clinically important progression in the 4 clinical settings when using the SDD as the threshold value. The MCID (mean 2.3) of the Larsen/Scott method was much smaller than its SDD (5.8), and the sensitivity for detecting clinically important progression by applying the SDD as threshold was consequently low (mean 51%), accompanied by high specificity (mean 99%). This study suggested that the SDD of the Sharp/van der Heijde method can be used as the MCID, i.e., as the threshold level for individual response criteria. The SDD of the Larsen/Scott method, however, turned out to be too insensitive to use as the threshold for individual clinically relevant change. This study further explored the role of the MCID in individual clinically relevant change.

Van der Heijde D. et al. as part of the Outcome Measures in Rheumatoid Arthritis Clinical Trials (OMERACT) Imaging Task Force explored the MCID in this same situation. The following conclusions and recommendations were made: the smallest detectable difference (SDD) beyond measurement error is a good starting point to define MCID; SDD is study-specific; SDD should be reported for all radiographic endpoints used in a trial as a quality control; the expert panel approach is a reasonable method to define MCID, but defined in this way MCID may be smaller than current SDD; more research is needed to validate expert panel based MCID in different datasets and with different experts; a predictive, data driven MCID is the ultimate goal, but is not yet available; the SDD can be used as a proxy for MCID until a data driven MCID is available; analysis at the group level (comparison of means or medians) should remain primary in studies that include progression of joint damage as outcome measure; and the proportion of patients showing more progression than the SDD is a secondary outcome measure. (van der Heijde D, Lassere M, Edmonds J, Kirwan J, Strand V, Boers M, Minimal clinically important difference in plain films in RA: group discussions, conclusions, and recommendations, OMERACT Imaging Task Force, J Rheumatol, 2001 April;28(4):914-7).

Beaton et al. reviewed MCID publications for the taxonomy of MCID, methods to determine MCID, its clinical importance, and other variations in MCID values. These authors concluded that the MCID will be context-specific factor or value rather than a fixed number. (Beaton D E, Boers M, Wells G A, Many faces of the minimal clinically important difference (MCID): a literature review and directions for future research, Curr Opin Rheumatol, 2002 March;14(2):109-14).

Hays and Woolley reviewed some of the vulnerabilities in the MCID and found that the attempt to define a single MCID is problematic for a number of reasons and recommend caution in the search for the MCID holy grail. Specifically, absolute thresholds are suspect because they ignore the cost or resources required to produce a change in HRQOL. In addition, these authors found that there are several practical problems in estimating the MCID, including: (i) the estimated magnitude varies depending on the distributional index and the external standard or anchor; (ii) the amount of change might depend on the direction of change; and (iii) the meaning of change depends on where you start (baseline value). (Hays R D, Woolley J M, The concept of clinically meaningful difference in health-related quality-of-life research. How meaningful is it?, Pharmacoeconomics, 2000 November; 18(5):419-23).

Chemotherapy is a field where it is well-understood that some agents cause severe toxicity, and combination therapy is necessary to overcome resistance or a lack of efficacy with some agents. Chemotherapy of cancer involves use of highly toxic drugs with narrow therapeutic indices. Although progress has been made in the chemotherapeutic treatment of selected malignancies, most adult solid cancers remain highly refractory to treatment. Nonetheless, chemotherapy is the standard of care for most disseminated solid cancers. Chemotherapy often results in a significant fraction of treated patients suffering unpleasant or life-threatening side effects while receiving little or no clinical benefit; other patients may suffer few side effects and/or have complete remission or even cure. Chemotherapy is also expensive, not just because the drugs are often costly, but also because administering highly toxic drugs requires close monitoring by carefully trained personnel, and because hospitalization is often required for treatment of (or monitoring for) toxic drug reactions. Information that would allow patients to be divided into likely responder vs. non-responder (or likely side effect) groups, only the former to receive treatment, would therefore also have a significant impact on the economics of cancer drug use.

Several methods for predicting response to chemotherapy in individual patients have been investigated over the years, ranging from the use of biochemical markers to testing drugs on a patient's cultured tumor cells. None of these methods has proven sufficiently informative and practical to gain wide acceptance. However, there are some specific examples of tests useful for predicting toxicity. For example, a diagnostic test to predict side effects associated with the antineoplastic drugs 6-mercaptopurine, 6-thioguanine and azathioprine has begun to gain wide acceptance, particularly among pediatric oncologists. Severe toxicity of thiopurine drugs is associated with deficiency of the enzyme thiopurine methyltransferase (TPMT). Currently most TPMT testing is done using an enzyme assay, however the TPMT gene has been cloned and mutations associated with low TPMT levels have been identified; genetic testing is beginning to supplant enzyme assays because genetic tests are more easily standardized and economical.

While there are no good tests that predict positive chemotherapeutic response, there is demonstrated utility to measuring estrogen and progesterone receptor levels in cancer tissue before selecting therapy directed at modulating hormonal state. Measuring genetic variation in proteins that mediate the effects of chemotherapy drugs is in some respects analogous to measuring ER and PR levels, which mediate the effects of hormones.

Leukovorin (folinic acid) is the most widely used 5-FU modulator, however a variety of other molecules have been used with 5-FU, including, for example, interferon-alpha, hydroxyurea, N-phosphonacetyl-L-aspartate, dipyridamole, levamisole, methotrexate, trimetrexate glucuronate, cisplatin and radiotherapy. S-1 is a novel oral anticancer drug, composed of the 5-FU prodrug tegafur plus gimestat (CDHP) and otastat potassium (Oxo) in a molar ratio of 1:0.4:1, with CDHP inhibiting dihydropyrimidine dehydrogenase in order to prolong 5-FU concentrations in blood and tumour and Oxo present as a gastrointestinal protectant. Some of these regimens show promising results, but no clear improvement over 5-FU/leukovorin.

The conversion of Folinic Acid (FA) to tetrahydrofolate (5,10THF) can occur via several routes. Intracellular reduced folate levels can potentiate 5-FU action by increasing 5,10-methylenetetrahydrofolate levels (5,10-methyleneTHF), thereby stabilizing the ternary inhibitory complex formed with thymidylate synthase and FdUMP. This is the basis for therapeutic modulation of 5-FU with FA. Conversion of folinic acid (5-formylTHF) to 5,10-methenylTHF, the precursor of 5,10-methyleneTHF, requires methenyltetrahydrofolate synthetase. Also, levels of 5,10-methyleneTHF may be affected directly by the activity of methyleneltetrahydrofolate dehydrogenase, methyleneltetrahydrofolate reductase, serine transhydroxymethylase and the glycine cleavage system enzymes.

Human cells have five concentrative nucleoside transporters with varying patterns of tissue distribution (see review by Wang et al., 1997). Two transporters, one with preference for purines and one for pyrimidines have been cloned recently (Felipe et al., 1998). 5-FU entry into cells may be modulated by activity of these transporters, particularly the pyrimidine transporter, although one prospective randomized clinical trial in which the nucleoside transport inhibitor dipyramidole was paired with 5-FU and FA failed to show a difference in outcome compared to 5-FU/FA alone (Kohne et al., 1995). Several folate transport systems have been identified in human cells. Folate receptor 1 (FR1) is a high affinity (nanomolar range) receptor for reduced folates. Three restriction fragment length polymorphisms (RFLPs) have been reported at the FR1 locus (Campbell et al., 1991). Reduced folates are also transported by folate receptor gamma and by a low affinity (1 uM) folate transporter. 15-fold variation in levels of folate transporter have been described in unselected tumor cell lines (Moscow et al., 1997).

In accord with the pathway description above, variation in either expression levels or intrinsic activity of the proteins involved in (i) cellular uptake of pyrimidines or reduced folate, (ii) conversion of 5-FU to the nucleotide form FdUMP, FUTP or FdUTP, (iii) catabolism of 5-FU, (iv) conversion of folinic acid to 5,10-methylenetetrahydrofolate or (iv) depletion of cellular 5,10-methylenetetrahydrofolate may be causally related to variation in clinical effect of 5-FU/FA.

While examples above concern 5-FU/FA action and genes which are expected to modulate such action, it is also useful to utilize genes involved in folate transport and metabolism generally. A number of these genes are also involved in 5-FU/FA action. In concert with the identification of useful genes involved in folate transport and metabolism, certain drug classes are used for treatment of identified disorders, along with a brief characterization of the action of the drug. Exemplary drugs are identified within the individual classes. Variable response of patients to administration of drugs of these classes, or administration of the specific drugs can be used in identifying variances responsible for such variable response. As described above, those variances can then be used in diagnostic tests, methods of selecting a treatment, methods of treating a patient, or other methods utilizing genetic variance information as otherwise described.

A wide spectrum of diseases is treated with drugs that affect folate metabolism. Some drugs are used in the treatment of several diseases. All of the listed drugs are frequently used in combination with other drugs. For example methotrexate is used in cancer chemotherapy with cytoxan and fluoruracil to treat breast cancer, among other combinations.

Many novel antifolate compounds with unique pharmacologic properties are currently in clinical development. These newer antifolates differ from methotrexate, the most widely used and studied drug in this class, in terms of their lipophilicity, cellular transport mechanism, level of polyglutamation, and specificity for inhibiting folate-dependent enzymes, such as dihydrofolate reductase, thymidylate synthase, or glycinamide ribonucleotide formyltransferase. The new folate analogs include quinazoline derivatives such as ZD 1694 (Tomudex, AstraZeneca) which requires Reduced Folate Carrier (RFC) mediated cell uptake and polyglutamation by Folylpolyglutamate Synthetase (FPGS); ZD9331 (AstraZeneca), which requires the RFC but is not polyglutamated by FPGS; LY231514 or permetrexed (Alimta, Eli Lilly Research Labs, Indianapolis, Ind.) is a multitargeted pyrrolopyrimidine analogue antifolate which requires the RFC and polyglutamation; GW1843 (1843U89, GlaxoWellcome) is a benzoquinazoline compound with potent TS inhibitory activity, and which enters cells via the RFC but is polyglutamated only to the diglutamate, which leads to higher cellular retention without augmenting TS inhibitory activity; AG337 (p.o. and i.v. forms) and AG331 (both by Agouron, La Jolla, Calif., now part of Pfizer, Inc.) are lipophilic TS inhibitors with action independent of the RFC and polyglutamation by FPGS; trimetrexate (US Bioscience) is a; Aminopterin is an older drug which has received renewed attention recently; edatrexate, piritrexim and lometrexol are other antifolate drugs. More generally, 5,8-dideazaisofolic acid (LAHQ), 5,10-dideazatetrahydrofolic acid (DDATHF), and 5-deazafolic acid are structures into which a variety of modifications have been introduced in the pteridine/quinazoline ring, the C9-N10 bridge, the benzoyl ring, and the glutamate side chain (see article below). Also Lilly have recently synthesized a new series of 2,4-diaminopyrido[2,3-d]pyrimidine based antifolates which are being evaluated both as antineoplastic and antiarthritic agents.

As was described above for drugs modulating genes involved in folate transport and metabolism, particular drug classes and exemplary drugs are identified which modulate the action of pyrimidine transport and metabolism genes. A variety of proliferative diseases, especially cancer, are treated with drugs that affect pyrimidine metabolism. All of the listed drugs are frequently used in combination with other drugs. There are a large number of pyrimidine analogs in clinical development for a wide variety of indications. One of the most common indications is cancer and leukemia and lymphoma of various types. For example, 2′,2′-difluorodeoxycytidine (gemcitabine; Gemzar) is a pyrimidine nucleoside drug with clinical efficacy in several common solid cancers; cytosine arabinoside (ARA-C) is another pyrimidine analog used in the treatment of leukemia; 2-chlorodeoxyadenosine and fludarabine (F-araA) are also used as antineoplastic drugs. 2′-deoxy-2′-(fluoromethyl-ene) cytidine (MDL 101,731, Kyowa Hakko Kogyo Co.), 2′,2′-difluorodeoxycytidine, 5-aza-2′deoxycytidine (decitabine), 5-azacytidine, 5-azadeoxycytidine, and are under development as antineoplastic drugs.

There are many potential candidate therapeutic interventions or drugs that can affect the folate and pyrimidine pathways. Categories of these are 5-FU prodrugs, drugs that affect DNA methylation pathways, and other drugs that have been developed for similar indications as 5-FU.

Examples of such drugs include capecitabine (Xeloda, Roche), a drug that is converted to 5-FU by a three-step pathway involving Carboxylesterase 1, Cytidine Deaminase and Thymidine Phosphorylase. Another 5-FU prodrug is 5′deoxy 5-FU (Furtulon, Roche) which is converted to 5-FU by Thymidine Phosphorylase and/or Uridine Phosphorylase. Another 5-FU prodrug is 1-(tetrahydro-2-furanyl)-5-fluorouracil (FT, ftorafur, Tegafur, Taiho—Bristol Myers Squibb), a prodrug that is converted to 5-FU by cytochrome P450 enzyme, CYP3A4.

A variety of drugs are being developed for similar indications as 5-FU, and/or are being tested in combinations with 5-FU/leukovorin. These include the new platinum compound oxaliplatin (L-OHP) and the topoisomerase I inhibitors irinotecan (CPT11, Pharmacia-UpJohn) and topotecan. Other drugs with activity against cancers usually treated with regimens containing 5-FU (e.g. metastatic colon cancer) include Suramin, a bis-hexasulfonated napthylurea; 6-hydroxymethylacylfulvene (HMAF; MGI 114); LY295501; bizelesin (U-7779; NSC615291), ONYX-015, monoclonal antibodies (e.g. 17-1A and MN-14), protein synthesis inhibitors such as RA 700, and angiogenesis inhibitors such as PF 4. Still other drugs may prevent colorectal cancer by preventing the formation of colorectal polyps (eg, cyclooxygenase inhibitors may induce apoptosis of polyps).

FU is a pyrimidine analog in clinical use since 1957. 5-FU is used in the standard treatment of gastrointestinal, breast and head and neck cancers. Clinical trials have also shown responses in cancer of the bladder, ovary, cervix, prostate and pancreas. The remainder of this discussion will concern colorectal cancer. 5-FU is used both in the adjuvant therapy of Dukes Stage B and C cancer and in the treatment of disseminated cancer. 5-FU alone produces partial remissions in 10-30% of advanced colorectal cancers, however only a few percent of patients have complete remissions. In the last 15 years a variety of biochemically motivated strategies for modulating 5-FU activity have been tested. For example, 5-FU has been used in combination with PALA, a pyrimidine synthesis inhibitor, to deplete cellular pools of UTP and thereby enhance formation of FUTP; in combination with methotrexate, to inhibit purine anabolism, leading to increased PRPP levels and consequent increased conversion of 5-FU to its active nucleotide metabolites; and in combination with folinic acid, which increases intracellular pools of reduced folate, driving formation of the ternary inhibitory complex formed by 5,10 methylenetetrahydrofolate, FdUMP and thymidylate synthase. Levamisole, interferon and alkylating agents have also been used in combination with 5-FU. 5-FU/Levamisole and 5-FU/FA are widely used in the adjuvant treatment of colon cancer, while 5-FU/FA is the most commonly used regimen for advanced colorectal cancer. Several prospective randomized trials of 5-FU/FA versus 5-FU alone in patients with advanced cancer have demonstrated up to two fold higher response rates to 5-FU/FA, while three of the studies also showed increased survival. Two major dosing regimens are used: 5-FU plus low dose FA given for five consecutive days followed by a 23 day interval, or once weekly bolus IV 5-FU plus high dose FA. The higher FA dose results in plasma FA concentrations of 1 to 10 uM, comparable to those required for optimal 5-FU/FA synergy in tissue culture, however low dose FA (20 mg/m.sup.2 vs. 500 mg/m.sup.2) has produced comparable clinical benefit. Ongoing clinical trials are designed to further test new drug combinations. In summary, relatively few patients—in the single digits—live longer as a result of 5-FU/FA, although significantly more have partial disease remission. The factors that determine which patients respond or have side effects are not known.

The biochemical pathways of 5-FU metabolism have been studied extensively. Likewise, folate metabolism has been well investigated and the enzymes that form and consume 5,10-methylenetetrahydrofolate are well known. The principal metabolic pathways that influence the pharmacologic action of 5-FU are summarized below.

5-FU metabolism and inhibition of thymidylate formation involve the following enzymes: 1. uridine phosphorylase; 2. thymidine phosphorylase; 3. orotate phosphoribosyl transferase; 4. thymidine kinase; 5. uridine kinase; 6. ribonucleotide reductase; 7. thymidylate synthase; 8. dCMP deaminase; 9. nucleoside monophosphate kinase; 10. nucleoside diphosphate kinase; 11. nucleoside diphosphatase or cytidylate kinase; and 12: thymine phosphorylase. FH2=dihydrofolate, FH4=tetrahydrofolate.

De Novo and Salvage Routes of Pyrimidine Nucleotide Formation (5-FU Anabolism) and Inhibition of Thymidylate Synthase—5-FU is a biologically inactive pyrimidine analog, which must be phosphorylated, and ribosylated to the nucleoside analog fluorodeoxyuridine monophosphate (FdUMP) to have clinical activity. FdUMP formation can occur via several routes. 5-FU may be converted by uridine phosphorylase to fluorouridine (FUdR; the reverse reaction is catalyzed by uridine nucleosidase) and then to fluorouridine monophosphate (FUMP) by uridine kinase, or FUMP may be formed from 5-FU in one step via transfer of a phosphoribosyl group from 5-phosphoribosyl-1-pyrophosphate (PRPP), catalyzed by orotate phosphoribosyl transferase. FUMP can be converted to FUDP and subsequently FUTP by a nucleoside monophosphate kinase and nucleoside diphosphate kinase, respectively. FUTP is incorporated into RNA by RNA polymerases, which may account in part for 5-FU toxicity as a result of effects on processing or function (e.g. translation). Alternatively, FUDP may be reduced to the dinucleotide level, FdUDP (fluorodeoxyuridine diphosphate) by ribonucleotide diphosphate reductase, a heterodimeric enzyme. FdUDP can then be converted to FdUTP by nucleoside diphosphate kinase and incorporated into DNA by DNA polymerases, which may account for some 5-FU toxicity. Fluoropyrimidine modified DNA may also be targeted by the nucleotide excision repair process. The more important path of FdUDP metabolism with respect to anticancer effects, however, is believed to be conversion to FdUMP by nucleoside diphosphatase (or cytidylate kinase, a bi-directional enzyme). dUMP is the precursor of dTMP in de novo pyrimidine biosynthesis, a reaction catalyzed by thymidylate synthase and which consumes 5,10-methylenetetrahydrofolate, producing 7,8 dihydrofolate. FdUMP, however, forms an inhibitory (probably covalent) complex with thymidylate synthase in the presence of 5,10-methylenetetrahydrofolate, thereby blocking formation of thymidylate (other than by the salvage pathway via thymidine kinase). The complex anabolism of FdUMP can be simplified by giving the deoxyribonucleoside of 5-FU, 5-fluorodeoxyuridine (also called floxuridine; FUdR), which can be converted to FdUMP in one step by thymidine kinase. However, FUdR is also rapidly converted back to 5-FU by the bi-directional enzyme thymidine phosphorylase.

Metabolic elimination of 5-FU occurs via a three step pathway leading to -alanine. The first and rate limiting enzyme in the elimination pathway is dihydropyrimidine dehydrogenase (DPD), which transforms more than 80% of a dose of 5-FU to the inactive dihydrofluorouracil form. Subsequently dihydropyrimidinase catalyzes opening of the pyrimidine ring to form 5-fluoro- -ureidopropionate and then -ureidopropionase (also called -alanine synthase) catalyzes formation of 2-fluoro- -alanine. The first two reactions are reversible.

The distribution of activity of these enzymes in human populations has not been established, however, a recent population survey of urinary pyrimidine levels in 1,133 adults revealed that levels of dihydrouracil range from 0-59 uM/g of creatinine, while uracil levels ranged from 0-130 uM/g creatinine (Hayashi et al., 1996), suggesting variation in the activity of enzymes of pyrimidine metabolism. It is worth noting that in animal studies catabolites of 5-FU apparently account for some fraction of 5-FU toxicity (Davis et al., 1994; Spector et al., 1995). This result is the rationale for current human trials of 5-FU combined with DPD inhibitors: if the 5-fluoro-metabolites are responsible for toxicity, then blocking their formation by inhibition of DPD, while simultaneously decreasing 5-FU dosage to compensate for the block in catabolism and excretion, should result in a better therapeutic index.

5-FU toxicity has been well documented in randomized clinical trials. Patients receiving 5-FU/FA are at even greater risk of toxic reactions and must be monitored carefully during therapy. A variety of side effects have been observed, affecting the gastrointestinal tract, bone marrow, heart and CNS. The most common toxic reactions are nausea and anorexia, which can be followed by life threatening mucositis, enteritis and diarrhea. Leukopenia is also a problem in some patients, particularly with the weekly dosage regimen. In a recent randomized trial of weekly vs. monthly 5-FU/FA there were 7 deaths related to drug toxicity among 372 treated patients (1.9%; Buroker et al. 1994). 31% of patients receiving the weekly regimen suffered diarrhea-requiring hospitalization for a median of 10 days. Other severe toxicity was present, which occurred at lower frequency, including leukopenia and stomatitis. In another example, 36% of patients receiving weekly bolus 5-FU plus FA (500 mg/m.sup.2), in a NSABP trial suffered NCI grade 3 toxicity (Wolmark et al., 1996). Clearly, toxicity is a major cost of 5-FU/FA therapy, measured both in patient suffering and in financial terms (the cost of care for drug induced illness).

Exemplary genes related to modulation of the action of 5-FU/FA have been analyzed for genetic variation; thymidylate synthase, ribonucleotide reductase (M1 subunit only), dihydrofolate reductase and dihydropyrimidine dehydrogenase cDNAs. 36 unrelated individuals were screened using 6 SSCP conditions and DNA sequencing. Other investigators have identified variances in MTHFR, methionine synthase and folate receptor.

5-FU is inactivated by the same metabolic pathway as thymine and uracil (see above). Dihydropyrimidine dehydrogenase deficiency (DPD) catalyzes the first, rate-limiting step in pyrimidine catabolism and accounts for elimination of most 5-FU. Normal individuals eliminate 5-FU with a half-life of about 10-15 minutes and excrete only 10% of a dose unchanged in the urine. In contrast, people genetically deficient in DPD eliminate 5-FU with a half-life of about 2.5 hours and excrete 90% of a dose unchanged in the urine (Diasio et al., 1988). DPD deficiency has two clinical presentations: (i) an inborn error of metabolism causing some degree of neurologic dysfunction or (ii) asymptomatic until revealed by exposure to 5-FU or other pyrimidine analogs. With either presentation there is combined hyperuraciluria and hyperthyminuria. The vastly increased 5-FU half-life in DPD deficient individuals causes severe toxicity and even death. Recently several mutations have been identified in DPD genes of deficient individuals (Wei et al., 1996), however none of these alleles appears to occur at appreciable frequency, so the cause of wide population variation in DPD levels is still not understood.

Population surveys of DPD activity in normal individuals have been performed using blood and liver samples and show wide variation. These studies reveal a broad unimodal Gaussian distribution of DPD activity over a 7 to 14 fold range, with some individuals having very low or even undetectable levels. For example Etienne et al. (1994) report DPD activity ranging from 0.065 to 0.559 nM/min/mg protein in a study of 152 men and 33 women, while Fleming et al. (1993) found DPD activity in 66 cancer patients varied from 0.17 to 0.77 nM/min/mg protein. Lu et al. (1995) found 18-fold variation in liver DPD assayed in 138 individuals. Milano and Etienne (1994) suggested that the frequency of heterozygous and homozygous deficiency is 3% and 0.1%, respectively. The DNA sequence alterations responsible for null DPD alleles do not account for the high population variability (Ridge et al., 1997).

Intratumoral DPD levels have been measured in patients receiving 5-FU chemotherapy. When complete responders were compared to partial or non-responders, DPD levels were lower in the compete responders (Etienne et al., 1995). Leukocyte DPD levels has also been measured in patients receiving 5-FU/FA chemotherapy. When patients were divided into 3 groups: high, medium and low DPD activity, the frequency of serious side effects was highest in the low DPD group and vice versa (Katona et al., 1997).

More than 85% of an injected dose of 5-FU is rapidly inactivated by dihydropyrimidine dehydrogenase (DPD) to therapeutically inactive catabolic products, however there is evidence that said catabolic products may be toxic to normal tissues. This has led to the development of DPD inhibitors with the aim to modify the therapeutic index of 5-FU. Several inhibitors in combination with 5-FU are under preclinical and clinical evaluation, including uracil and 5-chloro-2,4-dihydroxy pyridine, as modulators of 5-FU derived from its prodrug tegafur and 5-ethynyluracil as a modulator of 5-FU itself (Eniluracil, 776C85; Glaxo Wellcome Inc, Research Triangle Park, N.C.). Other compounds with DPD inhibitory activity include 5-propynyluracil. (For a review of DPD inhibitors see: Diasio, R B Improving 5-FU with a Novel Dihydropyrimidine Dehydrogenase Inactivator, Oncology 1998, March; 12(3 Suppl. 4):51-6).

The power of genetic analysis can be augmented by biochemical studies of alternate allelic forms of enzymes. Biochemical data on the distribution of activity of a series of enzymes in a biochemical pathway provides the basis for metabolic flux analysis (Keightly, 1996).

In light of the above, there exists a general need or desire to transfer molecular diagnostic knowledge from the research and development laboratory into a clinical laboratory setting to appropriately select, dose, and evaluate therapeutic interventions.

There also is a need or desire for determining therapeutic toxicity to immunosuppressive therapy and to predict and evaluate therapeutic efficacy for immunosuppressive therapies for autoimmune diseases and cancers.

There also exists a need or desire to use genetic and phenotypic markers before or during the early stages of treatment to predict a patient's risk for toxicity and adverse side effects and to monitor drug metabolite levels in order to reduce the side effects associated with immunosuppressive therapy.

There is further a need or desire for determining a drug metabolite level in a subject having an autoimmune disease or cancer during immunosuppressive therapy.

There also exists a need or desire for optiminzing the dose of immunosuppressive therapy and assessing biotransformation and genetic or phenotypic contributors in individual patients to optimize the therapeutic efficacy of immunosuppressive therapy while minimizing the toxic side effects.

### SUMMARY OF THE INVENTION

In response to the challenges discussed above, a method for effectively measuring risk for therapeutic toxicity before or after starting therapy and to predict and evaluate therapeutic efficacy in chemotherapy treatment of cancer and immunosuppressive and biologic therapy of autoimmune and immune-mediated disorders in order to improve treatment response and improve health outcomes has been developed.

The method of the present invention to effectively measure a risk profile for therapeutic toxicity of a subject having an autoimmune disease or cancer and predict and evaluate therapeutic efficacy of immunosuppressive therapies for autoimmune diseases and cancers prior to starting therapy includes determining the subject's risk profile for therapeutic toxicity from at least one immunosuppressive agent utilizing an index of genetic polymorphisms and phenotypes, and if the subject's risk profile is not acceptable to the physician and the subject, administering to the subject another immunosuppressive agent appropriate to the subject's risk profile.

The method of the present invention can be used for cancers including all forms treated by chemotherapy and autoimmune diseases including rheumatoid arthritis (RA), psoriatic arthritis (PA), juvenile idiopathic arthritis (JRA), systemic lupus erythematosus (SLE), and inflammatory bowel disease (IBD). The method of the present invention can also be used on both adult and pediatric subjects. The therapeutic toxicity of the present invention includes common toxicities both hematologic and hepatotoxic.

The at least one immunosuppressive agent of the present invention includes azathioprine, 6-mercaptopurine, methotrexate, mycophenolate mofetil, cyclophosphomide, 5-fluorouracil, capecitabine, irinotecan, gemcitabine HCl, leflunomide, and pemetrexed.

The index of genetic polymorphisms and phenotypes of the present invention include genetic polymorphism and phenotypic markers. The genetic polymorphism and phenotypic markers of the present invention include thymidylate synthase (TS), Dihydropyrimidine Dehydrogenase (DPD), thymidine phosphorylase (TP), Methyltetrahydrofolate Reductase (MTHFR), thiopurine methyl transferase (TPMT), IMP dehydrogenase (IMPDH), inosine triphosphate pyrophosphatase (ITPA), aldehyde dehydrogenase (ALDH1A1 and ALDH3A1), human equilibrative nucleoside transporter 1 (hENT1), deoxycytidine kinase (dCK), and nitrobenzylmercaptopurine ribonucleoside (NBMPR), uridine diphosphoglucuronosyl transferase 1A1, 1A7, and 1A9 (UGT1A1*28, UGT1A7*2/*2, UGT1A7*3/*3, UGT1A9-118 (dT)(9/9)), carboxylesterase 2, cytochrome P450 (CYP) 3A4, topoisomerase-I, dihydroorotate dehydrogenase (DHODH), uridine monophosphate (UMP), methyltetrahydrofolate reductase (MTHFR alleles C677T; A1298C), AICAR transformylase (ATIC C347G) alleles (347GG; 347 CG; 347GG), Thymidylate Synthase (2 or 3 tandem repeats TSER *2/*3) alleles (*3/*3; *3/*2; *2/*2), Reduced Folate Carrier (RFC-1 G80A) genotype (80GG; 80GA; 80AA), inosine-monophosphate dehydrogenase (IMPDH), CYP3A4/5, CYP2C8, and UDP-glucuronosyltransferases 1A9 and 2B7.

The genetic polymorphisms and phenotypic markers of the present invention may be determined in the source of the cellular compartments selected from the subject's liver, heart, muscle, brain, nerve, stomach, pancreas, colon, bone, blood, or other tissue. The genetic polymorphisms and phenotypic markers of the present invention wherein the genetic polymorphisms may be determined by utilizing ELISA, TaqMan, PCR, Invader, or other similar technologies. The genetic polymorphisms and phenotypic markers of the present invention wherein the phenotypic markers may be determined utilizing HPLC, TLC, electrochemical analysis, mass spectroscopy, refractive index spectroscopy (RI), Ultra-Violet spectroscopy (UV), fluorescent analysis, radiochemical analysis, Near-InfraRed spectroscopy (Near-IR), Nuclear Magnetic Resonance spectroscopy (NMR), Light Scattering analysis (LS), or other similar technologies.

In one embodiment of the present invention, a method to effectively measure a risk profile for therapeutic toxicity of a subject having an autoimmune disease or cancer and predict and evaluate therapeutic efficacy of immunosuppressive therapies for autoimmune diseases and cancers after starting therapy includes determining the subject's risk profile for therapeutic toxicity from at least one immunosuppressive agent utilizing an index of genetic polymorphisms and phenotypes, and if the subject's risk profile is not acceptable to the physician and the subject, stopping therapy and administering to the subject another immunosuppressive agent appropriate to the subject's risk profile.

In another embodiment of the present invention, a method to effectively measure a risk profile for therapeutic toxicity of a subject having an autoimmune disease or cancer and predict and evaluate therapeutic efficacy of immunosuppressive therapies for autoimmune diseases and cancers prior to starting therapy includes determining the subject's risk profile for therapeutic toxicity from at least one immunosuppressive agent utilizing an index of genetic polymorphisms and phenotypes; if the subject's risk profile is acceptable to the physician and the subject, administering to the subject the at least one immunosuppressive agent appropriate to the subject's risk profile; determining a drug metabolite level in the subject following about month one of therapy wherein a drug metabolite level of about 0.125 of the mean steady state metabolite level expected for a stable dose of therapy indicates the subject is about 19 times more likely to achieve therapeutic response at about months 4 to 6 of therapy and a drug metabolite level less than 0.125 of the mean steady state metabolite level indicates the need to increase the amount of the at least one immunosuppressive agent administered to the subject subsequently or the need to administer another immunosuppressive agent appropriate to the subject's drug metabolite level; determining a drug metabolite level in the subject following about month two of therapy wherein a drug metabolite level of about 0.25 of the mean steady state metabolite level expected for a stable dose of therapy indicates the subject is about 7 times more likely to achieve therapeutic response at about months 4 to 6 of therapy and a drug metabolite level less than 0.25 of the mean steady state metabolite level indicates the need to increase the amount of the at least one immunosuppressive agent administered to the subject subsequently or the need to administer another immunosuppressive agent appropriate to the subject's drug metabolite level; determining a drug metabolite level in the subject following about month three of therapy wherein a drug metabolite level of about 0.75 of the mean steady state metabolite level expected for a stable dose of therapy indicates the subject is about 17 times more likely to achieve therapeutic response at about months 4 to 6 of therapy and a drug metabolite level less than 0.75 of the mean steady state metabolite level indicates the need to increase the amount of the at least one immunosuppressive agent administered to the subject or the need to administer another immunosuppressive agent appropriate to the subject's drug metabolite level; measuring periodically the drug metabolite level of the subject on maintenance therapy to ensure treatment compliance and continued therapeutic response by measuring minimal clinical important differences (MCID) in the drug metabolite levels of the subject wherein a MCID is when the subject's drug metabolite level changes beyond a standard error of measurement (SEM) or when the subject's drug metabolite level increases or decreases beyond the subject's relative therapeutic range by a factor greater than 1.33; decreasing the amount of the at least one immunosuppressive agent administered to the subject if the drug metabolite level increases beyond the subject's relative therapeutic range by a factor greater than 1.33; and increasing or reevaluating the amount of the at least one immunosuppressive agent administered to the subject if the drug metabolite level decreases beyond the subject's relative therapeutic range by a factor greater than 1.33.

The drug metabolites of this embodiment of the present invention include at least one of 6-dihydrofluorouracil (DHFU), 5′ deoxy-5′fluorocytidine (5′DFCR) and 5′deoxy-5′fluorouridine (5′DFUR) reported in mug/mL; 6-thioguanine and 6-methyl-mercaptopurine reported in ng/8×10.8 RBC; 4-hydroxycyclophosphamide and carboxyethylphosphoramide mustard reported by ng ml(−1); anti-metabolite 2′,2′-difluorodeoxycytidine (dFdC) reported in microg/mL and 2′,2′-difluorodeoxyuridine (dFdU) reported in microg/Lh.; SN-38; A77-1726, FK778, and LFM A13 reported in mg/L; methotrexate polyglutamates (MTX(Glu) 1-5) (monoglutamate, diglutamate, triglutamate, quartaglutamate, and pentaglutamate) reported in nmol/L and 7-hydroxymethotrexate reported in ng.h/mL; mycophenolic acid (MPA, free MPA, free fraction MPA) and its metabolites (MPAG, Acyl-MPAG) reported in mg/L; pemetrexed disodium (MTA) reported in mg/L; and pemetrexed poilyglutamates reported in nmol/L. The genetic polymorphisms and phenotypic markers and the drug metabolites of this embodiment of the present invention may be determined in the source of the cellular compartments selected from the subject's liver, heart, muscle, brain, nerve, stomach, pancreas, colon, bone, blood, or other tissue.

In a further embodiment of the present invention, a method to effectively measure a risk for therapeutic toxicity of a subject having an autoimmune disease or cancer and predict and evaluate therapeutic efficacy of immunosuppressive therapies for autoimmune diseases and cancers prior to starting therapy includes determining the subject's risk profile for therapeutic toxicity from the at least one immunosuppressive agent utilizing an index of genetic polymorphisms and phenotypes; if the subject's risk profile is acceptable to the physician and the subject, administering to the subject the at least one immunosuppressive agent appropriate to the subject's risk profile; determining a drug metabolite level in the subject after increasing the amount of the at least one immunosuppressive agent administered to the subject to determine the subject's ability to metabolize the immunosuppressive therapy; determining the subject's therapeutic response drug metabolite level by measuring the drug metabolite level at a time when the subject is responding to immunosuppressive therapy; measuring periodically the drug metabolite level of the subject on maintenance therapy to ensure treatment compliance and continued therapeutic response by measuring minimal clinical important differences (MCID) in the drug metabolite levels of the subject wherein a MCID is when the subject's drug metabolite level changes beyond a standard error of measurement (SEM) or when the subject's drug metabolite level increases or decreases beyond the subject's relative therapeutic range by a factor greater than 1.33; decreasing the amount of the at least one immunosuppressive agent administered to the subject if the drug metabolite level increases beyond the subject's relative therapeutic range by a factor greater than 1.33; and increasing or reevaluating the amount of the at least one immunosuppressive agent administered to the subject if the drug metabolite level decreases beyond the subject's relative therapeutic range by a factor greater than 1.33.

In a further embodiment of the present invention, a method to effectively optimize the selection and dose of immunosuppressive therapies of a subject having an autoimmune disease or cancer to improve therapeutic efficacy and reduce therapeutic toxicity prior to starting concomitant biologic therapy includes determining the subject's risk profile for therapeutic toxicity from at least one immunosuppressive agent utilizing an index of genetic polymorphisms and phenotypes; if the subject's risk profile is acceptable to the physician and the subject, administering to the subject concomitantly with the biologic therapy the at least one immunosuppressive agent appropriate to the subject's risk profile; determining the subject's therapeutic response drug metabolite level by measuring the drug metabolite level at a time when the subject is responding to immunosuppressive therapy; administering a dose of the at least one immunosuppressive agent appropriate to achieve optimal therapeutic response drug metabolite levels to improve therapeutic efficacy and minimize therapeutic toxicity from at least one biologic agent; measuring periodically the drug metabolite level of the subject on maintenance therapy to ensure treatment compliance and continued therapeutic response by measuring minimal clinical important differences (MCID) in the drug metabolite levels of the subject wherein a MCID is when the subject's drug metabolite level changes beyond a standard error of measurement (SEM) or when the subject's drug metabolite level increases or decreases beyond the subject's relative therapeutic range by a factor greater than 1.33; decreasing the amount of the immunosuppressive agent administered to the subject if the drug metabolite level increases beyond the subject's relative therapeutic range by a factor greater than 1.33; and increasing or reevaluating the amount of the at least one immunosuppressive agent administered to the subject if the drug metabolite level decreases beyond the subject's relative therapeutic range by a factor greater than 1.33.

The at least one biologic agent of this embodiment of the present invention includes infliximab, adalimumab, rituximab, etanercept, natalizumab, and abatacept.

In a further embodiment of the present invention, a method to effectively optimize the selection and dose of immunosuppressive therapies of a subject having an autoimmune disease or cancer to improve therapeutic efficacy and reduce therapeutic toxicity prior to starting concomitant biologic therapy includes determining the subject's risk profile for therapeutic toxicity from at least one immunosuppressive agent utilizing an index of genetic polymorphisms and phenotypes after the subject has failed to respond to the immunosuppressive agent; if the subject's risk profile is acceptable to the physician and the subject, administering to the subject concomitantly with the biologic therapy the at least one immunosuppressive agent appropriate to the subject's risk profile; determining the subject's therapeutic response drug metabolite level by measuring the drug metabolite level at a time when the subject is responding to immunosuppressive therapy; administering a dose of the at least one immunosuppressive agent appropriate to achieve optimal therapeutic response drug metabolite levels to improve therapeutic efficacy and minimize therapeutic toxicity from at least one biologic agent; measuring periodically the drug metabolite level of the subject on maintenance therapy to ensure treatment compliance and continued therapeutic response by measuring minimal clinical important differences (MCID) in the drug metabolite levels of the subject wherein a MCID is when the subject's drug metabolite level changes beyond a standard error of measurement (SEM) or when the subject's drug metabolite level increases or decreases beyond the subject's relative therapeutic range by a factor greater than 1.33; decreasing the amount of the at least one immunosuppressive agent administered to the subject if the drug metabolite level increases beyond the subject's relative therapeutic range by a factor greater than 1.33; and increasing or reevaluating the amount of the at least one immunosuppressive agent administered to the subject if the drug metabolite level decreases beyond the subject's relative therapeutic range by a factor greater than 1.33.

In a further embodiment of the present invention, a method to effectively measure a risk profile for therapeutic toxicity of a subject having an autoimmune disease or cancer and predict and evaluate therapeutic efficacy of immunosuppressive therapies for autoimmune diseases and cancers prior to starting induction therapy includes determining the subject's risk profile for therapeutic toxicity from at least one immunosuppressive agent utilizing an index of genetic polymorphisms and phenotypes; if the subject's risk profile is acceptable to the physician and the subject, administering to the subject the at least one immunosuppressive agent appropriate to the subject's risk profile to induce response; determining a drug metabolite level in the subject after increasing the amount of the at least one immunosuppressive agent administered to the subject to determine the subject's ability to metabolize the immunosuppressive therapy; determining the subject's induced therapy response or failure to respond by measuring the therapeutic drug metabolite level; determining the subject's risk profile for therapeutic toxicity from the at least one immunosuppressive agent prior to starting maintenance therapy; if the subject's risk profile is acceptable to the physician and the subject, administering to the subject the at least one immunosuppressive agent for maintenance therapy appropriate to the subject's risk profile; determining a therapeutic drug metabolite level in the subject after increasing the amount of the at least one immunosuppressive agent administered to the subject to determine the subject's ability to metabolize the immunosuppressive therapy; determining the subject's therapeutic response drug metabolite level by measuring the drug metabolite level at a time when the subject is responding to immunosuppressive therapy; measuring periodically the drug metabolite level of the subject on maintenance therapy to ensure treatment compliance and continued therapeutic response by measuring minimal clinical important differences (MCID) in the drug metabolite levels of the subject wherein a MCID is when the subject's drug metabolite level changes beyond a standard error of measurement (SEM) or when the subject's drug metabolite level increases or decreases beyond the subject's relative therapeutic range by a factor greater than 1.33; decreasing the amount of the at least one immunosuppressive agent administered to the subject if the drug metabolite level increases beyond the subject's relative therapeutic range by a factor greater than 1.33; and increasing or reevaluating the amount of the at least one immunosuppressive agent administered to the subject if the drug metabolite level decreases beyond the subject's relative therapeutic range by a factor greater than 1.33.

The at least one immunosuppressive agent used to induce response of this embodiment of the present invention includes mycophenolate mofetil, cyclophosphomide, leflunomide, and rituximab. The at least one immunosuppressive agent used to maintain therapy of this embodiment of the present invention includes azathioprine, 6-mercaptopurine, leflunomide, and methotrexate.

These and other embodiments are more fully described in connection with the drawings and detailed description.

### BRIEF DESCRIPTION OF DRAWINGS

FIG. 1 is a graph of observational data set to demonstrate relative prevalence of index scores versus prevalence of side effect.

FIG. 2 illustrates thiopurine genotypes, phenotypes and metabolites.

FIG. 3 illustrates methotrexate genotypes, phenotypes, and metabolites.

FIG. 4 illustrates 5-Fluorouracil genotypes, phenotypes, and metabolites.

FIG. 5 illustrates irinotecan genotypes, phenotypes, and metabolites.

FIG. 6 is a graph illustrating the correlation of methotrexate metabolite levels (MTXPG (Glu-3)) to probability of a good response to therapy.

FIG. 7 is a table demonstrating a dose escalation and optimization model for immunosuppressant therapy.

FIG. 8 is a model comparing dose escalations with metabolite levels that indicate a high probability of response at months 4 to 6.

FIG. 9 illustrates dose escalation versus metabolite level predicting high probability of response in months 4 to 6 for methotrexate in the treatment of RA.

FIG. 10 illustrates dose escalation versus metabolite level predicting high probability of response in months 4 to 6 for Azathioprine in the treatment of Crohn's Disease.

FIG. 11 illustrates dose escalation versus metabolite level predicting high probability of response in months 4 to 6 for Azathioprine in the treatment of SLE.

### DETAILED DESCRIPTION OF THE INVENTION

The present invention relates to a method for effectively measuring risk for therapeutic toxicity utilizing indexes of genetic polymorphisms and phenotypic markers before or after starting therapy and a method to predict and evaluate therapeutic efficacy utilizing measurements of therapeutic drug metabolites in chemotherapy treatment of cancer and immunosuppressive and biologic therapy of autoimmune and immune-mediated disorders in order to improve treatment response and improve health outcomes. The present invention also provides methods of determining a therapeutic drug metabolite level for the subject at different doses and places in time and correlating the said therapeutic drug metabolite level with clinical efficacy.

The present invention relates to treatment of all cancers including those treated by chemotherapy and autoimmune diseases including rheumatoid arthritis (RA), psoriatic arthritis (PA), juvenile idiopathic arthritis (JRA), systemic lupus erythematosus (SLE), and inflammatory bowel disease (IBD) wherein the subject has an autoimmune disease or cancer. The present invention can be utilized for either an adult or a pediatric subject. Additionally, the therapeutic toxicity of the present invention includes common toxicities both hematologic and hepatotoxic.

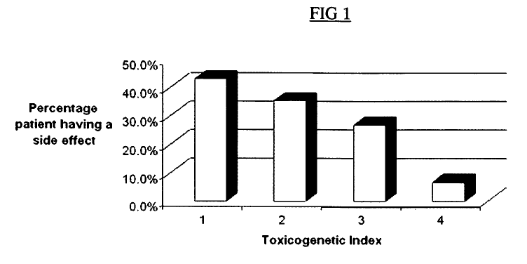

The method of the present invention includes determining the subject's risk profile for therapeutic toxicity from at least one immunosuppressive agent before or after starting immunosuppressive therapy utilizing indexes of genetic polymorphisms and phenotypic markers. If the risk profile is acceptable to the physician and subject then administering the at least one immunosuppressive agent and if the risk profile is not acceptable then administering another appropriate immunosuppressive agent. In one embodiment, after starting immunosuppressive therapy, if the risk profile is not acceptable to the physician and subject, then stopping therapy and administering another appropriate immunosuppressive agent. The higher the number or index score determined for the subject's risk profile, then the greater the risk of therapeutic toxicity. See FIG. 1 which illustrates an observational data set to demonstrate the relative prevalence of index scores versus the prevalence of side effects. The index of genetic polymorphisms and phenotypes is a multivariate analysis of multiple genetic polymorphisms or phenotypic marks wherein the index can predict a subject's risk potential for toxicity to specific immunosuppressive therapy.

The present invention relates to the use of at least one immunosuppressive agent for treatment of cancer or autoimmune diseases. The at least one immunosuppressive agent includes azathioprine, 6-mercaptopurine, methotrexate, mycophenolate mofetil, cyclophosphomide, 5-fluorouracil, capecitabine, irinotecan, gemcitabine HCl, leflunomide, and pemetrexed.

The genetic polymorphisms and phenotypic markers of the present invention include thymidylate synthase (TS), Dihydropyrimidine Dehydrogenase (DPD), thymidine phosphorylase (TP), Methyltetrahydrofolate Reductase (MTHFR), thiopurine methyl transferase (TPMT), IMP dehydrogenase (IMPDH), inosine triphosphate pyrophosphatase (ITPA), aldehyde dehydrogenase (ALDH1A1 and ALDH3A1), human equilibrative nucleoside transporter 1 (hENT1), deoxycytidine kinase (dCK), and nitrobenzylmercaptopurine ribonucleoside (NBMPR), uridine diphosphoglucuronosyl transferase 1A1, 1A7, and 1A9 (UGT1A1*28, UGT1A7*2/*2, UGT1A7*3/*3, UGT1A9-118 (dT)(9/9)), carboxylesterase 2, cytochrome P450 (CYP) 3A4, topoisomerase-I, dihydroorotate dehydrogenase (DHODH), uridine monophosphate (UMP), methyltetrahydrofolate reductase (MTHFR alleles C677T; A1298C), AICAR transformylase (ATIC C347G) alleles (347GG; 347 CG; 347GG), Thymidylate Synthase (2 or 3 tandem repeats TSER *2/*3) alleles (*3/*3; *3/*2; *2/*2), Reduced Folate Carrier (RFC-1 G80A) genotype (80GG; 80GA; 80AA), inosine-monophosphate dehydrogenase (IMPDH), CYP3A4/5, CYP2C8, and UDP-glucuronosyltransferases 1A9 and 2B7.

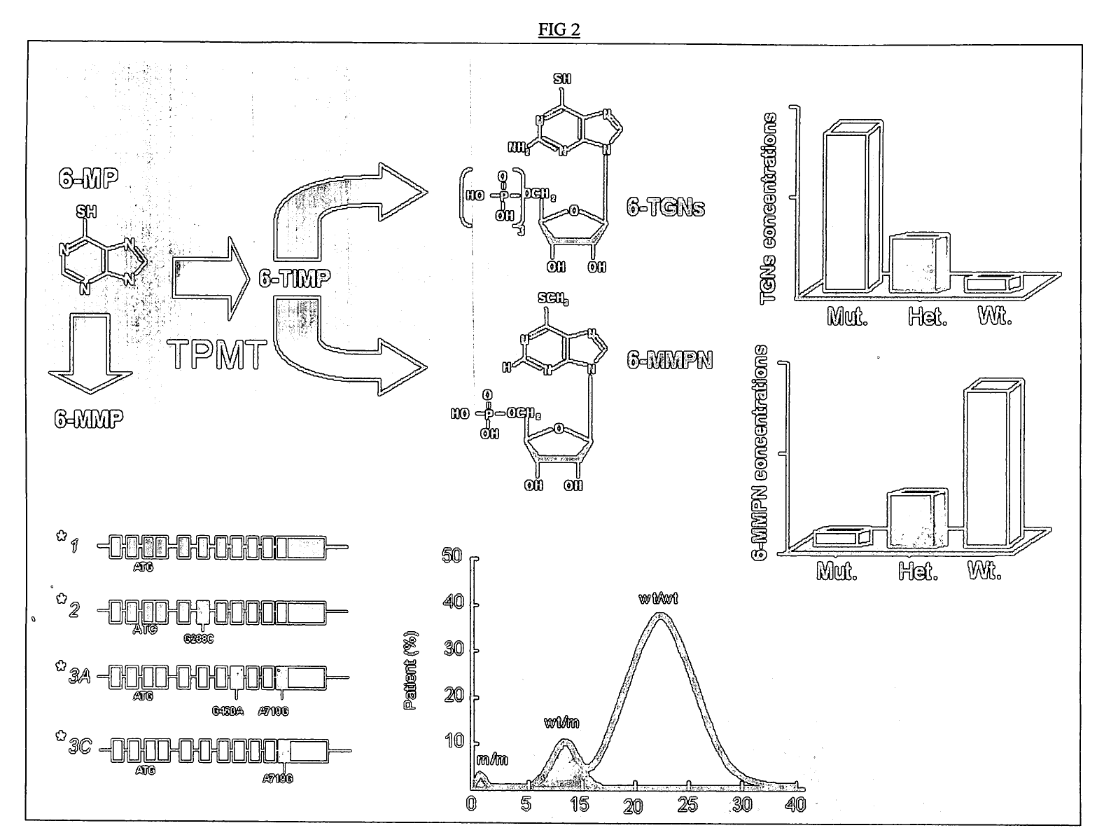

Thiopurines are used to treat subjects with SLE for maintenance therapy and to treat subjects with moderate to severe Crohns disease to avoid or reduce glucocorticoid therapy. The present invention involves a genotypic and phenotypic index for the thiopurines including thiopurine methyl transferase (TPMT), IMP dehydrogenase (IMPDH), and inosine triphosphate pyrophosphatase (ITPA) to predict a subject's risk for severe and prevalent adverse events including leukopenia, pancreatitis, and hepatotoxicity. See FIG. 2 illustrating thiopurine metabolism, genotypes, phenotypes, and metabolites.

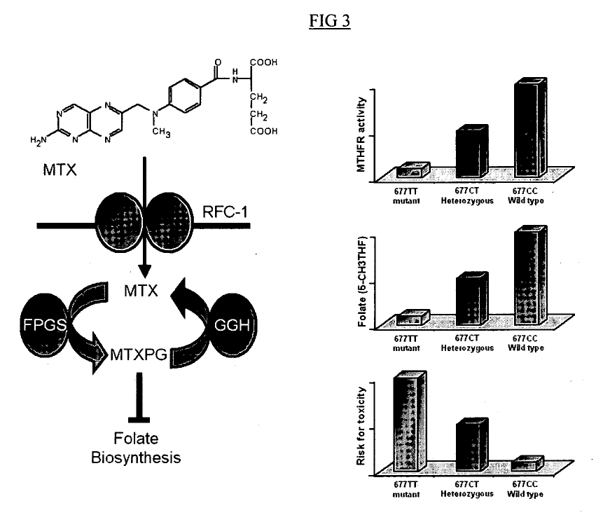

Methotrexate (MTX) is used widely in rheumatoid arthritis as monotherapy or in combination with other disease modifying anti-rheumatic drugs (DMARDs). The present invention involves genotypic and phenotypic index for MTX that includes thymidylate synthase (TS), methyltetrahydrofolate reductase (MTHFR), and other SNPs and enzymes involved in the purine and pyrimidine pathways involved in folate metabolism to predict hepatoxicity, gastrointestinal duress, alopecia, and other adverse events. See FIG. 3 illustrating methotrexate genotypes, phenotypes, and metabolites.

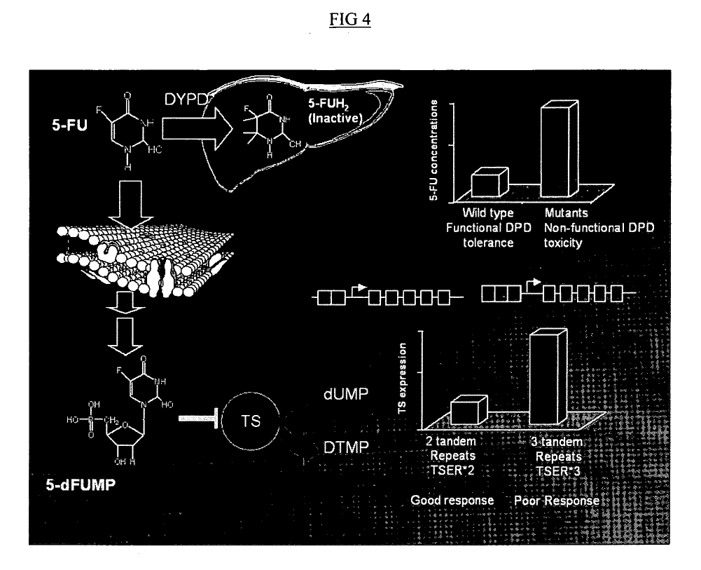

5-Fluorouracil (5-FU) and capecitabine (its pro-drug) are widely-used chemotherapy agents. The present invention involves a genotypic and phenotypic index for 5-FU and capecitabine that includes genetic polymorphisms and phenotypic markers of Thymidylate Synthase (TS), Dihydropyrimidine Dehydrogenase (DPD), thymidine phosphorylase (TP) and Methyltetrahydrofolate Reductase (MTHFR) to predict severe toxicities to these chemotherapies. See FIG. 4 which illustrates 5-FU genotypes, phenotypes, and metabolites.

Cyclophosphamide (CYC) is a widely-used immunosuppressant for SLE. The present invention involves a genotypic or phenotypic index for CYC that includes genetic polymorphisms and phenotypic markers including aldehyde dehydrogenase (ALDH1A1 and ALDH3A1).

Gemcitabine HCl (Gemzar, Eli Lilly & Company) (GEM) is a widely used chemotherapy agent for pancreatic, lung, and breast cancers. The present invention involves a genotypic or phenotypic index for GEM that includes genetic polymorphisms and phenotypic markers for human equilibrative nucleoside transporter 1 (hENT1), deoxycytidine kinase (dCK), and nitrobenzylmercaptopurine ribonucleoside (NBMPR) associates with severe toxicity to gemcitabine HCl.

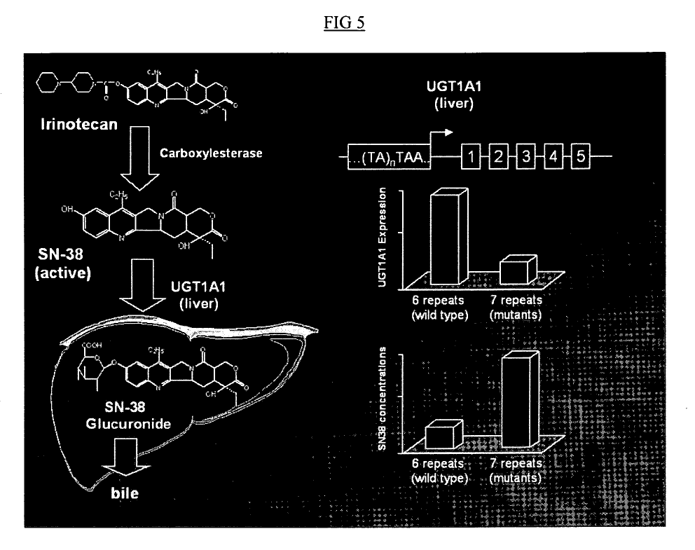

Irinotecan (Camptosar, Pfizer Inc.) (IRN) is a standard of care topoisomerase-I inhibitor chemotherapy agent, often times used in conjunction with 5-FU and leukovorin (FA). The present invention involves a genotypic or phenotypic index for IRN that includes uridine diphosphoglucuronosyl transferase 1A1, 1A7, and 1A9 (UGT1A1*28, UGT1A7*2/*2, UGT1A7*3/*3, UGT1A9-118 (dT)(9/9)), carboxylesterase 2, cytochrome P450 (CYP) 3A4, and topoisomerase-I. See FIG. 5 which illustrates irinotecan genotypes, phenotypes, and metabolites.

Leflunomide (Arava, Sanofi-Aventis) (LEF) is a DMARD used for rheumatoid arthritis. The present invention involves a genotypic or phenotypic index for LEF that includes thymidylate synthase (TS), dihydroorotate dehydrogenase (DHODH), and uridine monophosphate (UMP).

Mycophenolate mofetil (Cellcept, Roche) (MMF) is a widely used immunosuppressant agent in transplantation and SLE. The present invention involves a genotypic or phenotypic index for MMF including inosine-monophosphate dehydrogenase (IMPDH), CYP3A4/5, CYP2C8, UDP-glucuronosyltransferases 1A9 and 2B7.

Pemetrexed (Alimta, Eli Lilly & Company) (PEM) is a new folate analog chemotherapy agent used in mesothelioma, NSCLC, and other cancers. The present invention involves a genotypic or phenotypic index for PEM that includes thymidylate synthase (TS), Dihydropyrimidine Dehydrogenase (DPD), thymidine phosphorylase (TP) and Methyltetrahydrofolate Reductase (MTHFR).

The genetic polymorphisms, phenotypes, and drug metabolites may be determined in the source of the cellular compartments which are selected from a subject's liver, heart, muscle, brain, nerve, stomach, pancreas, colon, bone, blood, or other tissue. The genetic polymorphisms may be determined by utilizing ELISA, TaqMan, PCR, Invader, or other similar technology. The phenotypic markers may be determined utilizing HPLC, TLC, electrochemical analysis, mass spectroscopy, refractive index spectroscopy (R1), ultra-violet spectroscopy (UV), fluorescent analysis, radiochemical analysis, Near-infrared spectroscopy (near-IR), nuclear magnetic resonance spectroscopy (NMR) and light scattering analysis (LS).

In another embodiment, the drug metabolite level is periodically measured to ensure treatment compliance and continued therapeutic response by measuring minimal clinical important differences (MCID) in the drug metabolite levels of the subject. An MCID is when the subject's drug metabolite level changes beyond a standard error of measurement (SEM) or if the drug metabolite level increases or decreases beyond the subject's relative therapeutic range by a factor greater than 1.33. If the drug metabolite level increases by a factor greater than 1.33, then the amount of the at least one immunosuppressive agent administered is decreased or reevaluated due to changes in the subject's drug metabolism; if the drug metabolite level decreases by a factor greater than 1.33, then the amount of the at least one immunosuppressive agent administered is increased or reevaluated due to non-compliance by the subject or changes in the subject's drug metabolism.

Once response is achieved a subject's therapeutic drug metabolite level can be determined and used as a benchmark for future measurements to ensure continued response. The present invention suggests that a subject's therapeutic drug metabolite level to denote response is individual, and as such, the present invention measures a minimal clinical important difference (MCID) from each subject's therapeutic drug metabolite level of response, rather than imposing a population based prevalent threshold.

### EXAMPLE 1

Subject A with rheumatoid arthritis achieves therapeutic response to MTX at a MTXPG triglutmate level of 52 nmol/L. If Subject A's therapeutic drug metabolite level of MTX decreases by more than 13 nmol/L or increases by more than 17 nmol/L, then Subject A has attained a MCID in its metabolite level and indicates a clinical change in Subject A's therapeutic response, demanding a change in dose or discussion about compliance to therapy. Thus, Subject A has a therapeutic range of MTXPG (Glu-3) from 39 to 69 nmol/L, respectively.

### EXAMPLE 2

Subject B with SLE maintains therapeutic response to CYC by using AZA at a 6-TG level of 187 pmol. If Subject B's therapeutic drug metabolite level of AZA decreases by 47 nmol or increases by more than 62 pmol, then Subject B has attained a MCID in its metabolite level and indicates a clinical change in Subject B's therapeutic response, demanding a change in dose or discussion about compliance to therapy. Thus, Subject B has a therapeutic range of 6-TG from 140 pmol to 249 pmol.

### EXAMPLE 3

Subject C with psoriatic arthritis achieves therapeutic response to MTX at a MTXPG (Glu-3) level of 70 nmol/L. If Subject C is no longer responding to therapy in 12 months, then the therapeutic drug metabolite level can be measured to determine if a change in the subject's metabolite level has occurred. If Subject C's level has decreased by 17 nmol/L, then Subject B has achieved a MCID in the drug metabolite level suggesting that Subject C is no longer responding to therapy, due to drug resistance, non-compliance, or drug-drug interactions.

The drug metabolites include at least one of 6-dihydrofluorouracil (DHFU), 5′ deoxy-5′fluorocytidine (5′DFCR) and 5′deoxy-5′fluorouridine (5′DFUR) reported in mug/mL; 6-thioguanine and 6-methyl-mercaptopurine reported in ng/8×10.8 RBC; 4-hydroxycyclophosphamide and carboxyethylphosphoramide mustard reported by ng ml(−1); anti-metabolite 2′,2′-difluorodeoxycytidine (dFdC) reported in microg/mL and 2′,2′-difluorodeoxyuridine (dFdU) reported in microg/Lh.; SN-38; A77-1726, FK778, and LFM A13 reported in mg/L; methotrexate polyglutamates (MTX(Glu) 1-5) (monoglutamate, diglutamate, triglutamate, quartaglutamate, and pentaglutamate) reported in nmol/L and 7-hydroxymethotrexate reported in ng.h/mL; mycophenolic acid (MPA, free MPA, free fraction MPA) and its metabolites (MPAG, Acyl-MPAG) reported in mg/L; pemetrexed disodium (MTA) reported in mg/L; and pemetrexed poilyglutamates reported in nmol/L.

Thiopurines are used to treat subjects with SLE for maintenance therapy and to treat subjects with moderate to severe Crohns disease to avoid or reduce glucocorticoid therapy. The present invention involves determining the therapeutic drug metabolite levels for thiopurines that include 6-thioguanine (6-TG) and 6-methyl-mercaptopurine (6-MMPR) reported in ng/8×10.8 RBC to measure and predict therapeutic efficacy, as well as monitor compliance.

Methotrexate (MTX) is used widely in rheumatoid arthritis as monotherapy or in combination with other disease modifying anti-rheumatic drugs (DMARDs). The present invention involves determining the therapeutic drug metabolite levels for methotrexate that include methotrexate polyglutamates (MTX(Glu) 1-5) (i.e. monoglutamate, diglutamate, triglutamate, quartaglutamate, and pentaglutamate) reported in nmol/L and 7-hydroxymethotrexate reported in ng.h/mL to measure and predict therapeutic efficacy, as well as monitor compliance.

5-Fluorouracil and capecitabine (its pro-drug) are widely-used chemotherapy agents. The present invention involves determining the therapeutic drug metabolite levels for 5-FU and capecitabine that include 6-dihydrofluorouracil (DHFU) 5′ deoxy-5′fluorocytidine (5′DFCR) and 5′deoxy-5′fluorouridine (5′DFUR) reported in mug/mL to measure and predict therapeutic efficacy, as well as monitor compliance. Cyclophosphamide (CYC) is a widely-used immunosuppressant for SLE. The present invention involves determining the therapeutic drug metabolite levels for CYC that may include 4-hydroxycyclophosphamide and/or carboxyethylphosphoramide mustard reported by ng ml(−1) to measure and predict therapeutic efficacy, as well as monitor compliance.

Gemcitabine HCl (Gemzar, Eli Lilly & Company) (GEM) is a widely used chemotherapy agent for pancreatic, lung, and breast cancers. The present invention involves determining the therapeutic drug metabolite levels for GEM that include anti-metabolite 2′,2′-difluorodeoxycytidine (dFdC) reported in microg/ml and 2′,2′-difluorodeoxyuridine (dFdU) reported in microg/Lh., to measure and predict therapeutic efficacy as well as toxicity.

Irinotecan (Camptosar, Pfizer Inc.) (IRN) is a standard of care topoisomerase-I inhibitor chemotherapy agent, often times used in conjunction with 5-FU and leukovorin (FA). The present invention involves determining the therapeutic drug metabolite levels for IRN that include SN-38 to measure and predict therapeutic efficacy as well as toxicity.

Leflunomide (Arava, Sanofi-Aventis) (LEF) is a DMARD used for rheumatoid arthritis. The present invention involves determining the therapeutic drug metabolite level for LEF that include A77-1726, FK778, and LFM A13 reported in mg/L to measure and predict therapeutic efficacy and toxicity, as well as monitor compliance.

Mycophenolate mofetil (Cellcept, Roche) (MMF) is a widely used immunosuppressant agent in transplantation and SLE. The present invention involves determining the therapeutic drug metabolite level for MMF that include mycophenolic acid (MPA, free MPA, free fraction MPA) and its metabolites (MPAG, Acyl-MPAG) reported in mg/L to measure and predict therapeutic efficacy and toxicity, as well as monitor compliance.

Pemetrexed (Alimta, Eli Lilly & Company) (PEM) is a new folate analog chemotherapy agent used in mesothelioma, NSCLC, and other cancers. The present invention involves determining the therapeutic drug metabolite level for PEM that may include pemetrexed disodium (MTA) and pemetrexed polyglutamates reported in mg/L and/or nmol/L, respectively, to measure and predict therapeutic efficacy and toxicity, as well as monitor compliance.

The present invention also provides methods of using the drug metabolite level to guide dosing changes (increase or decrease) by benchmarking response levels to measure against future metabolite levels where relapse may occur, and predicting future response based upon current metabolite levels and its associated metabolism. In one embodiment, the drug metabolite level in the subject is determined following about month one of therapy. If the drug metabolite level is about 0.125 of the mean steady state metabolite level expected for a stable dose of immunosuppressive therapy, then the subject is about 19 times more likely to achieve therapeutic response at about months 4 to 6 of therapy. If the drug metabolite level is less than about 0.125 of the mean steady state metabolite level, then the amount of the at least one immunosuppressive agent administered to the subject is increased during subsequent therapy or another appropriate immunosuppressive agent is administered. The determination of the subject's drug metabolite level is repeated following about month two and month three of therapy. At month two, if the drug metabolite level is about 0.25 of the mean steady state metabolite level expected for a stable dose therapy, then the subject is 7 times more likely to achieve therapeutic response at about months 4 to 6 of therapy; if the drug metabolite level is less than about 0.25, then the amount of immunosuppressive agent administered to the subject is increased during subsequent therapy or another appropriate immunosuppressive agent is administered. At month three, if the drug metabolite level is about 0.75 of the mean steady state metabolite level expected for a stable dose therapy, then the subject is 17 times more likely to achieve therapeutic response at about months 4 to 6 of therapy; if the drug metabolite level is less than about 0.75, then the amount of the at least one immunosuppressive agent administered to the subject is increased during subsequent therapy or another appropriate immunosuppressive agent is administered.

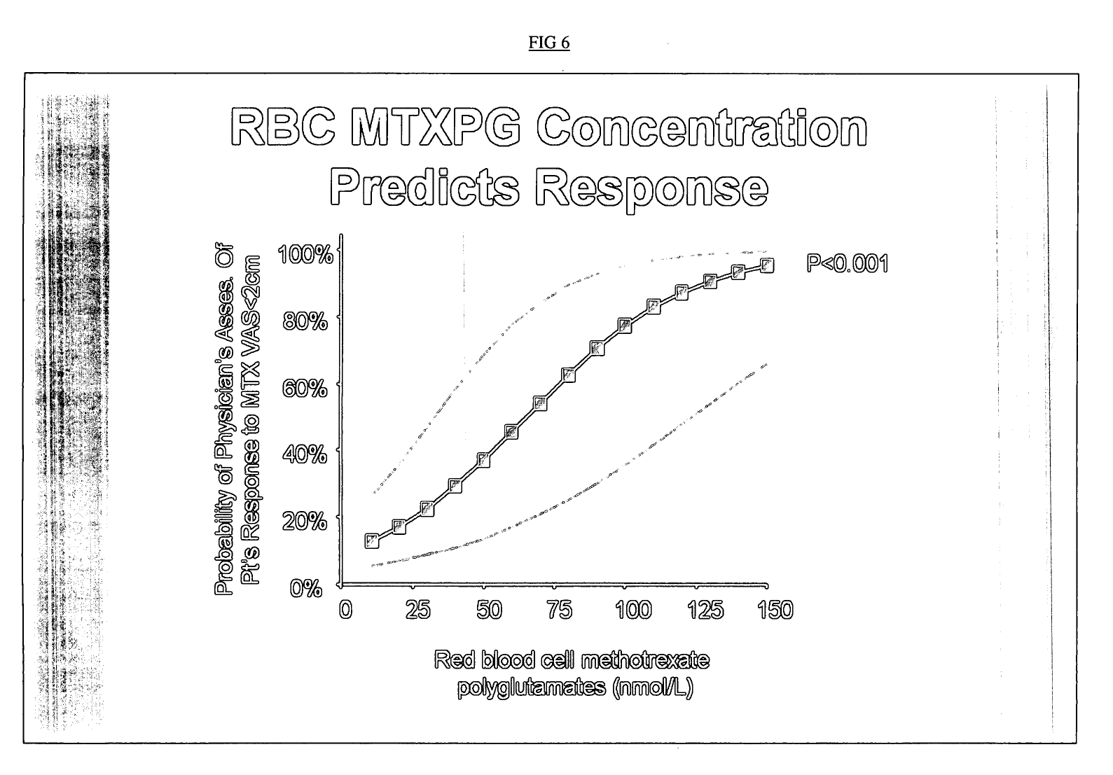

FIG. 6 illustrates the correlation between methotrexate metabolite levels (MTXPG (Glu-3)) and the probability of a good response to therapy. Subjects with a visual analog scale (VAS) score of ≦2 cm for physician's assessment of subject's response to MTX (n=57) were considered responders and were compared with subjects with a score of >2 cm (nonresponders; n=51). The solid line with squares shows the probability (P); the dotted lines show the 95% confidence intervals (derived from the logistic regression) for a VAS score of ≦2 cm for physician's assessment of subject's response to MTX. MTXPG₃ estimate=0.035±0.01 (P<0.001).

Drug metabolite levels can be used to guide dosing changes and Seidman et al. tried to establish relevant metabolite thresholds to guide thiopurine therapy for pediatric subjects with inflammatory bowel disease by establishing a 6-TGN level of 230 pmol×10.8 RBC correlated with therapeutic response and a level of 400 pmol×10.8 RBC correlated with toxicity. However, clinical practice suggests that population-based thresholds may not always be relevant to the individual patient and inter-patient and intra-patient variability inevitability exists.

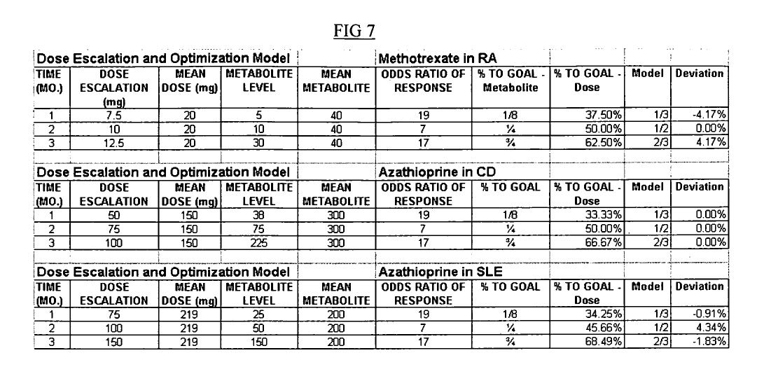

As show in FIG. 7, the present invention relates to a therapeutic drug metabolite level wherein in about Month 1 should be at least about 0.125 the anticipated mean metabolite level for therapeutic response to be achieved at Months 4 to 6. A therapeutic drug metabolite level in about Month 2 should be at least about 0.25 the anticipated mean metabolite level for therapeutic response to be achieved at Months 4 to 6. A therapeutic drug metabolite level in about Month 3 should be at least 0.75 the anticipated mean metabolite level for therapeutic response to be achieved at Months 4 to 6.

The present invention also relates to a method to measure drug metabolite levels as part of dose escalation to ensure that a subject is metabolizing the drug, and then predicting future response to therapy based upon early metabolomic, or drug metabolism. In one embodiment, the drug metabolite level of the subject is determined after increasing the amount of the at least one immunosuppressive agent administered to determine the subject's ability to metabolize the immunosuppressive therapy. If the subject's risk profile is acceptable to the physician and the subject, then maintenance therapy is administered to the subject.

The present invention involves a method of comparing the therapeutic drug metabolite level with anticipated dose escalations over a similar period of time. To achieve this therapeutic drug metabolite level, the present invention involves a method of dose escalation to achieve therapeutic response in Months 4 to 6, guided by the therapeutic drug metabolite level. A subject should have at least about ⅓ the mean dose following about Month 1 of therapy, at least about ½ the mean dose following about Month 2 of therapy, and at least about ⅔ the mean dose following about Month 3 of therapy to achieve the desired therapeutic response in Months 4 to 6.

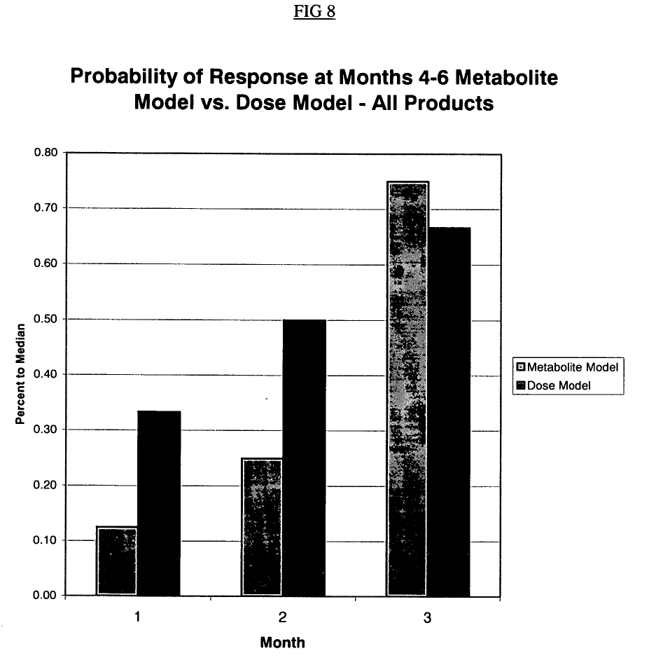

FIG. 8 is a model comparing dose escalations with metabolite levels that indicate a high probability of response at months 4 to 6. Dose escalations and metabolite levels are calculated as a percentage of their expected median at response.

FIG. 9 illustrates dose escalation versus metabolite level predicting high probability of response in months 4 to 6 for methotrexate in the treatment of RA. Median dose is expected to be 20 mg/week and median metabolite level for MTXPG (Glu-3) is expected to be 40 mmol/L.

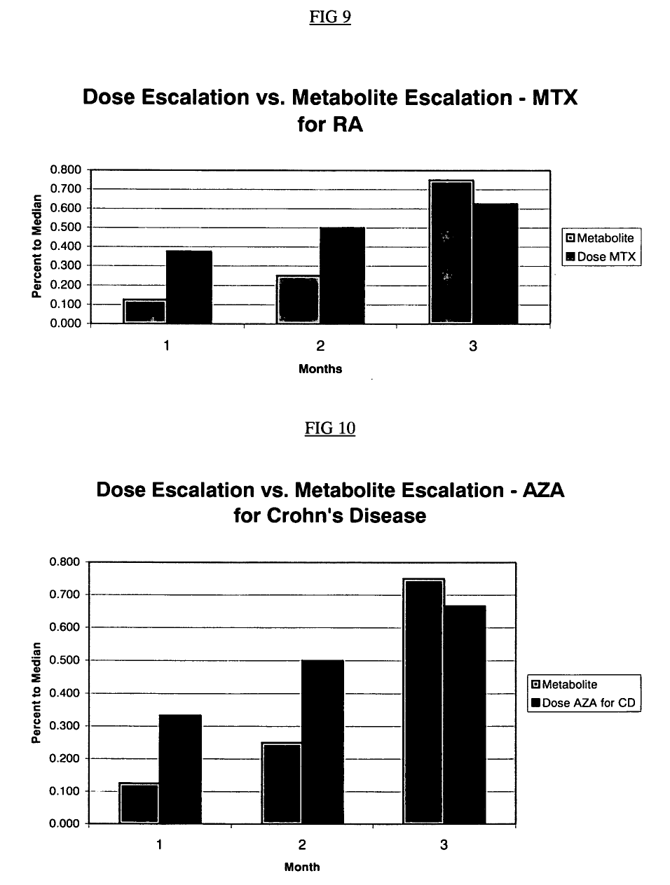

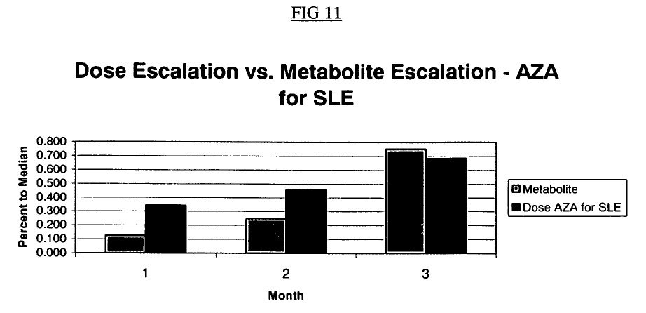

FIG. 10 illustrates dose escalation versus metabolite level predicting high probability of response in months 4 to 6 for Azathioprine in the treatment of Crohn's Disease. Median dose is expected to be 150 mg and median metabolite level for 6-TG is expected to be 200 pmol.

FIG. 11 illustrates dose escalation versus metabolite level predicting high probability of response in months 4 to 6 for Azathioprine in the treatment of SLE. Median dose is expected to be 200 mg and median metabolite level for 6-TG is expected to be 300 pmol.

The present invention also relates to drug treatment using immunosuppressive agents and their concomitant biologic agents in autoimmune disorders, as well as chemotherapy agents used in cancer. The present invention also relates to a method to determine specific therapeutic drug metabolite levels for the immunosuppressive agents that improve clinical efficacy and minimize adverse side effects of said biologic agents.

In one embodiment, if prior to starting concomitant biologic therapy the subject's risk profile is acceptable to the physician and the subject, then the at least one immunosuppressive agent is administered concomitantly with biologic therapy. Thereafter, the subject's therapeutic drug response metabolite level is measured at a time when the subject is responding to immunosuppressive therapy and the at least one immunosuppressive agent appropriate to achieve optimal therapeutic response drug metabolite levels is administered to improve therapeutic efficacy and minimize therapeutic toxicity from the at least one biologic agent. The subject's drug metabolite level is periodically measured during maintenance therapy to ensure treatment compliance and continued therapeutic response by measuring MCID.

The at least one biologic agent includes infliximb, adalimumab, rituximab, etanercept, natalizumab, and abatacept.

The present invention further relates to methods of utilizing immunosuppresant metabolite levels during maintenance therapy to maintain induced therapeutic response to therapy from early treatment.

While in the foregoing specification this invention has been described in relation to certain preferred embodiments thereof, and many details have been set forth for the purpose of illustration, it will be apparent to those skilled in the art that the invention is susceptible to additional embodiments and that certain details described herein can be varied considerably without departing from the basic principles of the invention.

We claim:

1. A method for effectively measuring risk for therapeutic toxicity of a subject having an autoimmune disease or cancer and predicting and evaluating therapeutic efficacy of immunosuppressive therapies for autoimmune diseases and cancers comprising the steps of:
determining a risk profile of the subject for therapeutic toxicity from at least one immunosuppressive agent utilizing an index of genetic polymorphisms and phenotypes; and
administering to the subject another immunosuppressive agent appropriate to the risk profile, if the risk profile is not acceptable to the physician and the subject.

2. The method of claim 1 wherein determining the risk profile for therapeutic toxicity from the at least one immunosuppressive agent is done prior to starting immunosuppressive therapy.

3. The method of claim 1 wherein determining the risk profile for therapeutic toxicity from at least one immunosuppressive agent is done after starting immunosuppressive therapy.

4. The method of claim 3 wherein administering to the subject another immunosuppressive agent appropriate to the risk profile is done after stopping therapy.

5. The method of claim 1 wherein the risk profile comprises a number or an index score.

6. The method of claim 5 wherein the risk of therapeutic toxicity is greater the higher the number or index score of the risk profile.

7. The method of claim 1 wherein the autoimmune disease or cancer comprises all forms of cancer treated by chemotherapy, rheumatoid arthritis (RA), psoriatic arthritis (PA), juvenile idiopathic arthritis (JRA), systemic lupus erythematosus (SLE), and inflammatory bowel disease (IBD).

8. The method of claim 1 wherein the at least one immunosuppressive agent comprises azathioprine, 6-mercaptopurine, methotrexate, mycophenolate mofetil, cyclophosphomide, 5-fluorouracil, capecitabine, irinotecan, gemcitabine HCl, leflunomide, and pemetrexed.

9. The method of claim 1 wherein the index of genetic polymorphisms and phenotypes comprises thymidylate synthase (TS), Dihydropyrimidine Dehydrogenase (DPD), thymidine phosphorylase (TP), Methyltetrahydrofolate Reductase (MTHFR), thiopurine methyl transferase (TPMT), IMP dehydrogenase (IMPDH), inosine triphosphate pyrophosphatase (ITPA), aldehyde dehydrogenase (ALDH1A1 and ALDH3A1), human equilibrative nucleoside transporter 1 (hENT1), deoxycytidine kinase (dCK), and nitrobenzylmercaptopurine ribonucleoside (NBMPR), uridine diphosphoglucuronosyl transferase 1A1, 1A7, and 1A9 (UGT1A1*28, UGT1A7*2/*2, UGT1A7*3/*3, UGT1A9-118 (dT)(9/9)), carboxylesterase 2, cytochrome P450 (CYP) 3A4, topoisomerase-I, dihydroorotate dehydrogenase (DHODH), uridine monophosphate (UMP), methyltetrahydrofolate reductase (MTHFR alleles C677T; A1298C), AICAR transformylase (ATIC C347G) alleles (347GG; 347 CG; 347GG), Thymidylate Synthase (2 or 3 tandem repeats TSER *2/*3) alleles (*3/*3; *3/*2; *2/*2), Reduced Folate Carrier (RFC-1 G80A) genotype (80GG; 80GA; 80AA), inosine-monophosphate dehydrogenase (IMPDH), CYP3A4/5, CYP2C8, and UDP-glucuronosyltransferases 1A9 and 2B7.

10. A method for effectively measuring risk for therapeutic toxicity of a subject having an autoimmune disease or cancer and predicting and evaluating therapeutic efficacy of immunosuppressive therapies for autoimmune diseases and cancers comprising the steps of:
determining a risk profile of the subject for therapeutic toxicity from at least one immunosuppressive agent utilizing an index of genetic polymorphisms and phenotypes;
administering to the subject the at least one immunosuppressive agent appropriate to the risk profile, if the risk profile is acceptable to the physician and the subject;
determining a drug metabolite level in the subject following about month one of therapy;
determining the drug metabolite level in the subject following about month two of therapy;
determining the drug metabolite level in the subject following about month three of therapy; and
measuring periodically the drug metabolite level of the subject to ensure treatment compliance and continued therapeutic response by measuring minimal clinical important differences (MCID) in the drug metabolite levels of the subject.

11. The method of claim 10 wherein a drug metabolite level of about 0.125 of the mean steady state metabolite level expected for a stable dose of therapy at about month one of therapy indicates the subject is likely to achieve therapeutic response at about months 4 to 6 of therapy and a drug metabolite level of less than about 0.125 of the mean steady state metabolite level expected for a stable dose of therapy indicates the need to increase the amount of the at least one immunosuppressive agent administered to the subject subsequently or the need to administer another immunosuppressive agent appropriate to the drug metabolite level of the subject.

12. The method of claim 10 wherein a drug metabolite level of about 0.25 of the mean steady state metabolite level expected for a stable dose of therapy at about month two of therapy indicates the subject is likely to achieve therapeutic response at about months 4 to 6 of therapy and a drug metabolite level of less than about 0.25 of the mean steady state metabolite level expected for a stable dose of therapy indicates the need to increase the amount the of the at least one immunosuppressive agent administered to the subject subsequently or the need to administer another immunosuppressive agent appropriate to the drug metabolite level of the subject.

13. The method of claim 10 wherein a drug metabolite level of about 0.75 of the mean steady state metabolite level expected for a stable dose of therapy at about month three of therapy indicates the subject is likely to achieve therapeutic response at about months 4 to 6 of therapy and a drug metabolite level of less than about 0.75 of the mean steady state metabolite level expected for a stable dose of therapy indicates the need to increase the amount of the at least one immunosuppressive agent administered to the subject subsequently or the need to administer another immunosuppressive agent appropriate to the drug metabolite level of the subject.

14. The method of claim 10 wherein determining the risk profile for therapeutic toxicity from the at least one immunosuppressive agent is done prior to starting immunosuppressive therapy.

15. The method of claim 10 wherein the risk profile comprises a number or an index score.

16. The method of claim 15 wherein the risk of therapeutic toxicity is greater the higher the number or index score of the risk profile.

17. The method of claim 10 wherein the autoimmune disease or cancer comprises all forms of cancer treated by chemotherapy, rheumatoid arthritis (RA), psoriatic arthritis (PA), juvenile idiopathic arthritis (JRA), systemic lupus erythematosus (SLE), and inflammatory bowel disease (IBD).

18. The method of claim 10 wherein the at least one immunosuppressive agent comprises azathioprine, 6-mercaptopurine, methotrexate, mycophenolate mofetil, cyclophosphomide, 5-fluorouracil, capecitabine, irinotecan, gemcitabine HCl, leflunomide, and pemetrexed.

19. The method of claim 10 wherein the index of genetic polymorphisms and phenotypes comprises thymidylate synthase (TS), Dihydropyrimidine Dehydrogenase (DPD), thymidine phosphorylase (TP), Methyltetrahydrofolate Reductase (MTHFR), thiopurine methyl transferase (TPMT), IMP dehydrogenase (IMPDH), inosine triphosphate pyrophosphatase (ITPA), aldehyde dehydrogenase (ALDH1A1 and ALDH3A1), human equilibrative nucleoside transporter 1 (hENT1), deoxycytidine kinase (dCK), and nitrobenzylmercaptopurine ribonucleoside (NBMPR), uridine diphosphoglucuronosyl transferase 1A1, 1A7, and 1A9 (UGT1A1*28, UGT1A7*2/*2, UGT1A7*3/*3, UGT1A9-118 (dT)(9/9)), carboxylesterase 2, cytochrome P450 (CYP) 3A4, topoisomerase-I, dihydroorotate dehydrogenase (DHODH), uridine monophosphate (UMP), methyltetrahydrofolate reductase (MTHFR alleles C677T; A1298C), AICAR transformylase (ATIC C347G) alleles (347GG; 347 CG; 347GG), Thymidylate Synthase (2 or 3 tandem repeats TSER *2/*3) alleles (*3/*3; *3/*2; *2/*2), Reduced Folate Carrier (RFC-1 G80A) genotype (80GG; 80GA; 80AA), inosine-monophosphate dehydrogenase (IMPDH), CYP3A4/5, CYP2C8, and UDP-glucuronosyltransferases 1A9 and 2B7.

20. The method of claim 10 wherein the drug metabolites comprise at least one of 6-dihydrofluorouracil (DHFU), 5′ deoxy-5′fluorocytidine (5′DFCR) and 5′deoxy-5′fluorouridine (5′DFUR) reported in mug/mL; 6-thioguanine and 6-methyl-mercaptopurine reported in ng/8×10.8 RBC; 4-hydroxycyclophosphamide and carboxyethylphosphoramide mustard reported by ng ml(−1); anti-metabolite 2′,2′-difluorodeoxycytidine (dFdC) reported in microg/mL and 2′,2′-difluorodeoxyuridine (dFdU) reported in microg/Lh.; SN-38; A77-1726, FK778, and LFM A13 reported in mg/L; methotrexate polyglutamates (MTX(Glu) 1-5) (monoglutamate, diglutamate, triglutamate, quartaglutamate, and pentaglutamate) reported in nmol/L and 7-hydroxymethotrexate reported in ng.h/mL; mycophenolic acid (MPA, free MPA, free fraction MPA) and its metabolites (MPAG, Acyl-MPAG) reported in mg/L; pemetrexed disodium (MTA) reported in mg/L; and pemetrexed poilyglutamates reported in nmol/L.

21. The method of claims 10 wherein the MCID is when the drug metabolite level of the subject changes beyond a standard error of measurement (SEM) or when the drug metabolite level increases or decreases beyond the relative therapeutic range of the subject by a factor greater than about 1.33.

22. The method of claim 21 wherein an increase in the MCID beyond the relative therapeutic range of the subject by a factor greater than about 1.33 indicates to decrease the amount of the at least one immunosuppressive agent administered to the subject.

23. The method of claim 21 wherein a decrease in the MCID beyond the relative therapeutic range of the subject by a factor greater than about 1.33 indicates to increase or reevaluate the amount of the at least one immunosuppressive agent administered to the subject.

24. A method for effectively measuring risk for therapeutic toxicity of a subject having an autoimmune disease or cancer and predicting and evaluating therapeutic efficacy of immunosuppressive therapies for autoimmune diseases and cancers comprising the steps of:
determining a risk profile of a subject for therapeutic toxicity from at least one immunosuppressive agent utilizing an index of genetic polymorphisms and phenotypes;
administering to the subject the at least one immunosuppressive agent appropriate to the risk profile, if the risk profile is acceptable to the physician and the subject;
determining a drug metabolite level in the subject after increasing the amount of the at least one immunosuppressive agent administered to determine the ability of the subject to metabolize the immunosuppressive therapy;
determining the therapeutic response drug metabolite level of the subject by measuring the drug metabolite level at a time when the subject is responding to the immunosuppressive therapy; and
measuring periodically the drug metabolite level of the subject on maintenance therapy to ensure treatment compliance and continued therapeutic response by measuring minimal clinical important differences (MCID).

25. The method of claim 24 wherein determining the risk profile for therapeutic toxicity from the at least one immunosuppressive agent is done prior to starting immunosuppressive therapy.

26. The method of claim 24 wherein the risk profile comprises a number or an index score.

27. The method of claim 26 wherein the risk of therapeutic toxicity is greater the higher the number or index score of the risk profile.

28. The method of claim 24 wherein the autoimmune disease or cancer comprises all forms of cancer treated by chemotherapy, rheumatoid arthritis (RA), psoriatic arthritis (PA), juvenile idiopathic arthritis (JRA), systemic lupus erythematosus (SLE), and inflammatory bowel disease (IBD).

29. The method of claim 24 wherein the at least one immunosuppressive agent comprises azathioprine, 6-mercaptopurine, methotrexate, mycophenolate mofetil, cyclophosphomide, 5-fluorouracil, capecitabine, irinotecan, gemcitabine HCl, leflunomide, and pemetrexed.

30. The method of claim 24 wherein the index of genetic polymorphisms and phenotypes comprises thymidylate synthase (TS), Dihydropyrimidine Dehydrogenase (DPD), thymidine phosphorylase (TP), Methyltetrahydrofolate Reductase (MTHFR), thiopurine methyl transferase (TPMT), IMP dehydrogenase (IMPDH), inosine triphosphate pyrophosphatase (ITPA), aldehyde dehydrogenase (ALDH1A1 and ALDH3A1), human equilibrative nucleoside transporter 1 (hENT1), deoxycytidine kinase (dCK), and nitrobenzylmercaptopurine ribonucleoside (NBMPR), uridine diphosphoglucuronosyl transferase 1A1, 1A7, and 1A9 (UGT1A1*28, UGT1A7*2/*2, UGT1A7*3/*3, UGT1A9-118 (dT)(9/9)), carboxylesterase 2, cytochrome P450 (CYP) 3A4, topoisomerase-I, dihydroorotate dehydrogenase (DHODH), uridine monophosphate (UMP), methyltetrahydrofolate reductase (MTHFR alleles C677T; A1298C), AICAR transformylase (ATIC C347G) alleles (347GG; 347 CG; 347GG), Thymidylate Synthase (2 or 3 tandem repeats TSER *2/*3) alleles (*3/*3; *3/*2; *2/*2), Reduced Folate Carrier (RFC-1 G80A) genotype (80GG; 80GA; 80AA), inosine-monophosphate dehydrogenase (IMPDH), CYP3A4/5, CYP2C8, and UDP-glucuronosyltransferases 1A9 and 2B7.

31. The method of claim 24 wherein the drug metabolites comprise at least one of 6-dihydrofluorouracil (DHFU), 5′ deoxy-5′fluorocytidine (5′DFCR) and 5′deoxy-5′fluorouridine (5′DFUR) reported in mug/mL; 6-thioguanine and 6-methyl-mercaptopurine reported in ng/8×10.8 RBC; 4-hydroxycyclophosphamide and carboxyethylphosphoramide mustard reported by ng ml(−1); anti-metabolite 2′,2′-difluorodeoxycytidine (dFdC) reported in microg/mL and 2′,2′-difluorodeoxyuridine (dFdU) reported in microg/Lh.; SN-38; A77-1726, FK778, and LFM A13 reported in mg/L; methotrexate polyglutamates (MTX(Glu) 1-5) (monoglutamate, diglutamate, triglutamate, quartaglutamate, and pentaglutamate) reported in nmol/L and 7-hydroxymethotrexate reported in ng.h/mL; mycophenolic acid (MPA, free MPA, free fraction MPA) and its metabolites (MPAG, Acyl-MPAG) reported in mg/L; pemetrexed disodium (MTA) reported in mg/L; and pemetrexed poilyglutamates reported in nmol/L.

32. The method of claims 24 wherein the MCID is when the drug metabolite level of the subject changes beyond a standard error of measurement (SEM) or when the drug metabolite level increases or decreases beyond the relative therapeutic range of the subject by a factor greater than about 1.33.

33. The method of claim 32 wherein an increase in the MCID beyond the relative therapeutic range of the subject by a factor greater than about 1.33 indicates to decrease the amount of the at least one immunosuppressive agent administered to the subject.

34. The method of claim 32 wherein a decrease in the MCID beyond the relative therapeutic range of the subject by a factor greater than about 1.33 indicates to increase or reevaluate the amount of the at least one immunosuppressive agent administered to the subject.

35. A method for effectively optimizing the selection and dose of immunosuppressive therapies of a subject having an autoimmune disease or cancer to improve therapeutic efficacy and reduce therapeutic toxicity prior to starting concomitant biologic therapy comprising the steps of:
determining a risk profile of the subject for therapeutic toxicity from at least one immunosuppressive agent utilizing an index of genetic polymorphisms and phenotypes;
administering to the subject concomitantly with biologic therapy the at least one immunosuppressive agent appropriate to the risk profile, if the risk profile is acceptable to the physician and the subject;
determining a therapeutic response drug metabolite level by measuring the drug metabolite level at a time when the subject is responding to the immunosuppressive therapy;
administering a dose of the at least one immunosuppressive agent appropriate to achieve optimal therapeutic response drug metabolite levels to improve therapeutic efficacy and minimize therapeutic toxicity from the at least one biologic agent; and
measuring periodically the drug metabolite level of the subject on maintenance therapy to ensure treatment compliance and continued therapeutic response by measuring minimal clinical important differences (MCID).

36. The method of claim 35 wherein the risk profile comprises a number or an index score.

37. The method of claim 36 wherein the risk of therapeutic toxicity is greater the higher the number or index score of the risk profile.

38. The method of claim 35 wherein the autoimmune disease or cancer comprises all forms of cancer treated by chemotherapy, rheumatoid arthritis (RA), psoriatic arthritis (PA), juvenile idiopathic arthritis (JRA), systemic lupus erythematosus (SLE), and inflammatory bowel disease (IBD).

39. The method of claim 35 wherein the at least one immunosuppressive agent comprises azathioprine, 6-mercaptopurine, methotrexate, mycophenolate mofetil, cyclophosphomide, 5-fluorouracil, capecitabine, irinotecan, gemcitabine HCl, leflunomide, and pemetrexed.

40. The method of claim 35 wherein the index of genetic polymorphisms and phenotypes comprises thymidylate synthase (TS), Dihydropyrimidine Dehydrogenase (DPD), thymidine phosphorylase (TP), Methyltetrahydrofolate Reductase (MTHFR), thiopurine methyl transferase (TPMT), IMP dehydrogenase (IMPDH), inosine triphosphate pyrophosphatase (ITPA), aldehyde dehydrogenase (ALDH1A1 and ALDH3A1), human equilibrative nucleoside transporter 1 (hENT1), deoxycytidine kinase (dCK), and nitrobenzylmercaptopurine ribonucleoside (NBMPR), uridine diphosphoglucuronosyl transferase 1A1, 1A7, and 1A9 (UGT1A1*28, UGT1A7*2/*2, UGT1A7*3/*3, UGT1A9-118 (dT)(9/9)), carboxylesterase 2, cytochrome P450 (CYP) 3A4, topoisomerase-I, dihydroorotate dehydrogenase (DHODH), uridine monophosphate (UMP), methyltetrahydrofolate reductase (MTHFR alleles C677T; A1298C), AICAR transformylase (ATIC C347G) alleles (347GG; 347 CG; 347GG), Thymidylate Synthase (2 or 3 tandem repeats TSER *2/*3) alleles (*3/*3; *3/*2; *2/*2), Reduced Folate Carrier (RFC-1 G80A) genotype (80GG; 80GA; 80AA), inosine-monophosphate dehydrogenase (IMPDH), CYP3A4/5, CYP2C8, and UDP-glucuronosyltransferases 1A9 and 2B7.

41. The method of claim 35 wherein the drug metabolites comprise at least one of 6-dihydrofluorouracil (DHFU), 5′ deoxy-5′fluorocytidine (5′DFCR) and 5′deoxy-5′fluorouridine (5′DFUR) reported in mug/mL; 6-thioguanine and 6-methyl-mercaptopurine reported in ng/8×10.8 RBC; 4-hydroxycyclophosphamide and carboxyethylphosphoramide mustard reported by ng ml(−1); anti-metabolite 2′,2′-difluorodeoxycytidine (dFdC) reported in microg/mL and 2′,2′-difluorodeoxyuridine (dFdU) reported in microg/Lh.; SN-38; A77-1726, FK778, and LFM A13 reported in mg/L; methotrexate polyglutamates (MTX(Glu) 1-5) (monoglutamate, diglutamate, triglutamate, quartaglutamate, and pentaglutamate) reported in nmol/L and 7-hydroxymethotrexate reported in ng.h/mL; mycophenolic acid (MPA, free MPA, free fraction MPA) and its metabolites (MPAG, Acyl-MPAG) reported in mg/L; pemetrexed disodium (MTA) reported in mg/L; and pemetrexed poilyglutamates reported in nmol/L.

42. The method of claim 35 wherein the MCID is when the drug metabolite level of the subject changes beyond a standard error of measurement (SEM) or when the drug metabolite level increases or decreases beyond the relative therapeutic range of the subject by a factor greater than about 1.33.

43. The method of claim 42 wherein an increase in the MCID beyond the relative therapeutic range of the subject by a factor greater than about 1.33 indicates to decrease the amount of the at least one immunosuppressive agent administered to the subject.

44. The method of claim 42 wherein a decrease in the MCID beyond the relative therapeutic range of the subject by a factor greater than about 1.33 indicates to increase or reevaluate the amount of the at least one immunosuppressive agent administered to the subject.

45. The method of claim 35 wherein the at least one biologic agent comprises infliximab, adalimumab, rituximab, etanercept, natalizumab, and abatacept.

46. The method of claim 35 wherein the determining the risk profile for therapeutic toxicity from at least one immunosuppressive agent utilizing an index of genetic polymorphisms and phenotypes is done after the subject has failed to respond to the at least one immunosuppressive agent.

47. A method for effectively measuring risk for therapeutic toxicity of a subject having an autoimmune disease or cancer and predicting and evaluating therapeutic efficacy of immunosuppressive therapies for autoimmune diseases and cancers prior to starting induction therapy comprising the steps of:
determining a risk profile of the subject for therapeutic toxicity from at least one immunosuppressive agent utilizing an index of genetic polymorphisms and phenotypes;
administering to the subject the at least one immunosuppressive agent appropriate to the risk profile to induce response, if the risk profile is acceptable to the physician and the subject;
determining a drug metabolite level in the subject after increasing the amount of the at least one immunosuppressive agent administered to determine the ability of the subject to metabolize the immunosuppressive therapy;
determining an induced therapy response or failure of the subject to respond by measuring a therapeutic drug metabolite level;
determining the risk profile for therapeutic toxicity from at least one immunosuppressive agent prior to starting maintenance therapy;
administering to the subject the at least one immunosuppressive agent appropriate to the risk profile to maintain therapy, if the risk profile is acceptable to the physician and the subject;
determining a drug metabolite level in the subject after increasing the amount of the at least one immunosuppressive agent administered to determine an ability of the subject to metabolize the immunosuppressive therapy;
determining the therapeutic drug metabolite level of the subject by measuring the drug metabolite level in the subject at a time when the subject is responding to the immunosuppressive therapy; and
measuring periodically the drug metabolite level of the subject on maintenance therapy to ensure treatment compliance and continued therapeutic response by measuring minimal clinical important differences (MCID).

48. The method of claim 47 wherein the at least one immunosuppressive agent to induce response comprises mycophenolate mofetil, cyclophosphomide, leflunomide, and rituximab.

49. The method of claim 47 wherein the at least one immunosuppressive agent to maintain therapy comprises azathioprine, 6-mercaptopurine, methotrexate, and leflunomide.

50. The method of claim 47 wherein the risk profile comprises a number or an index score.

51. The method of claim 50 wherein the risk of therapeutic toxicity is greater the higher the number or index score of the risk profile.

52. The method of claim 47 wherein the autoimmune disease or cancer comprises all forms of cancer treated by chemotherapy, rheumatoid arthritis (RA), psoriatic arthritis (PA), juvenile idiopathic arthritis (JRA), systemic lupus erythematosus (SLE), and inflammatory bowel disease (IBD).

53. The method of claim 47 wherein the index of genetic polymorphisms and phenotypes comprises thymidylate synthase (TS), Dihydropyrimidine Dehydrogenase (DPD), thymidine phosphorylase (TP), Methyltetrahydrofolate Reductase (MTHFR), thiopurine methyl transferase (TPMT), IMP dehydrogenase (IMPDH), inosine triphosphate pyrophosphatase (ITPA), aldehyde dehydrogenase (ALDH1A1 and ALDH3A1), human equilibrative nucleoside transporter 1 (hENT1), deoxycytidine kinase (dCK), and nitrobenzylmercaptopurine ribonucleoside (NBMPR), uridine diphosphoglucuronosyl transferase 1A1, 1A7, and 1A9 (UGT1A1*28, UGT1A7*2/*2, UGT1A7*3/*3, UGT1A9-118 (dT)(9/9)), carboxylesterase 2, cytochrome P450 (CYP) 3A4, topoisomerase-I, dihydroorotate dehydrogenase (DHODH), uridine monophosphate (UMP), methyltetrahydrofolate reductase (MTHFR alleles C677T; A1298C), AICAR transformylase (ATIC C347G) alleles (347GG; 347 CG; 347GG), Thymidylate Synthase (2 or 3 tandem repeats TSER *2/*3) alleles (*3/*3; *3/*2; *2/*2), Reduced Folate Carrier (RFC-1 G80A) genotype (80GG; 80GA; 80AA), inosine-monophosphate dehydrogenase (IMPDH), CYP3A4/5, CYP2C8, and UDP-glucuronosyltransferases 1A9 and 2B7.

54. The method of claim 47 wherein the drug metabolites comprise at least one of 6-dihydrofluorouracil (DHFU), 5′ deoxy-5′fluorocytidine (5′DFCR) and 5′deoxy-5′fluorouridine (5′DFUR) reported in mug/mL; 6-thioguanine and 6-methyl-mercaptopurine reported in ng/8×10.8 RBC; 4-hydroxycyclophosphamide and carboxyethylphosphoramide mustard reported by ng ml(−1); anti-metabolite 2′,2′-difluorodeoxycytidine (dFdC) reported in microg/mL and 2′,2′-difluorodeoxyuridine (dFdU) reported in microg/Lh.; SN-38; A77-1726, FK778, and LFM A13 reported in mg/L; methotrexate polyglutamates (MTX(Glu) 1-5) (monoglutamate, diglutamate, triglutamate, quartaglutamate, and pentaglutamate) reported in nmol/L and 7-hydroxymethotrexate reported in ng.h/mL; mycophenolic acid (MPA, free MPA, free fraction MPA) and its metabolites (MPAG, Acyl-MPAG) reported in mg/L; pemetrexed disodium (MTA) reported in mg/L; and pemetrexed poilyglutamates reported in nmol/L.

55. The method of claims 47 wherein the MCID is when the drug metabolite level of the subject changes beyond a standard error of measurement (SEM) or when the drug metabolite level increases or decreases beyond the relative therapeutic range of the subject by a factor greater than about 1.33.

56. The method of claim 55 wherein an increase in the MCID beyond the relative therapeutic range of the subject by a factor greater than about 1.33 indicates to decrease the amount of the at least one immunosuppressive agent administered to the subject.

57. The method of claim 55 wherein a decrease in the MCID beyond the relative therapeutic range of the subject by a factor greater than about 1.33 indicates to increase or reevaluate the amount of the at least one immunosuppressive agent administered to the subject.
